(19) United States
(12) Patent Application Publication
(10) Pub. No.: US 2016/0081005 A1
(43) Pub. Date: Mar. 17, 2016

(54) ROUTE FORMATION AND MESSAGE TRANSMISSION IN A DATA LINK GROUP OVER MULTIPLE CHANNELS

(71) Applicant: QUALCOMM Incorporated, San Diego, CA (US)

(72) Inventors: Abhishek Pramod Patil, San Diego, CA (US); George Cherian, San Diego, CA (US); Santosh Paul Abraham, San Diego, CA (US)

(21) Appl. No.: 14/835,178

(22) Filed: Aug. 25, 2015

Related U.S. Application Data
(60) Provisional application No. 62/051,798, filed on Sep. 17, 2014.

(51) Int. Cl. H04W 40/24; H04W 72/04; H04W 74/00; H04L 12/751; H04L 12/733

(52) U.S. Cl. CPC H04W 40/24; H04L 45/02; H04L 45/20; H04W 74/002; H04W 72/0453; H04W 84/12

(57) ABSTRACT

A method includes generating a first path request message and a second path request message at a first device of a data link group. The first device is configured to communicate via a plurality of wireless channels. The first path request message indicates a first media access control (MAC) address corresponding to a first wireless interface of the first device. The second path request message indicates a second MAC address corresponding to a second wireless interface of the first device. The method includes transmitting, via a first wireless channel, the first path request message from the first wireless interface to a second device of the data link group. The method further includes transmitting, via a second wireless channel, the second path request message from the second wireless interface to the second device. A path between devices of the data link group may span multiple wireless channels.

### I. CROSS REFERENCE TO RELATED APPLICATIONS

The present application claims priority from U.S. Provisional Patent Application No. 62/051,798, filed Sep. 17, 2014 and entitled “ROUTE FORMATION AND MESSAGE TRANSMISSION IN A DATA PATH GROUP OVER MULTIPLE CHANNELS,” the content of which is incorporated herein in its entirety.

### II. FIELD

The present disclosure is generally related to route formation and message transmission in a data link group over multiple channels.

### III. DESCRIPTION OF RELATED ART

Advances in technology have resulted in smaller and more powerful computing devices. For example, a variety of portable personal computing devices, including wireless telephones such as mobile and smart phones, tablets and laptop computers are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing and networking capabilities.

An example of a network that supports communication between electronic devices is provided by the Institute of Electrical and Electronics Engineers (IEEE) 802.11s standard. The IEEE 802.11s standard defines a hybrid wireless mesh protocol (HWMP). The HWMP defines path request messages that enable a first device of a mesh network to determine and to form a path to a second device of the mesh network. In the 802.11s standard, devices of the mesh network communicate via a single wireless channel. Many wireless devices, such as dual-band wireless devices, include multiple wireless interfaces. In order to take advantage of multiple wireless interfaces, some wireless devices are configured to communicate via multiple mesh networks. To enable communication between a first mesh network and a second mesh network, a fixed wireless device in both mesh networks is configured as a bridge node to provide data between the first mesh network and the second mesh network. The fixed wireless device configured as the bridge node may become overloaded, may introduce a single point-of-failure to the two mesh networks, and may reduce performance of communicating streams between the first mesh network and the second mesh network.

### IV. SUMMARY

In the present disclosure, devices in a data link group of a neighbor aware network (NAN) may exchange routing messages and form routes between the devices via multiple wireless channels. As used herein, a “data link group” refers to a group of devices that form a network and that share a type of data announcement, a time corresponding to data announcements (e.g., a paging window), security credentials, or a combination thereof As an example, a data link group may include an ad hoc wireless network, an ad hoc peer-to peer (p2p) wireless network, a wireless mesh network, such as a “social wireless fidelity (wi-fi) mesh,” or a subset of the ad hoc network or the wireless mesh network. By enabling one or more devices in the data link group to determine and to form routes and to exchange routing messages via multiple wireless channels, a first device in the data link group (or a first device in communication with the data link group) may send a message via a particular path over multiple wireless channels to a destination device. The particular path that spans multiple wireless channels may be selected because the particular path has a lower link metric than other paths to the destination device over a single wireless channel. A lower link metric may refer to a lower “weight” of the path, or portion of the path. Thus, the particular path may have a lowest link metric of all available paths and may be referred to as a “best route” spanning multiple channels.

Multiple devices of a data link group may include multiple wireless interfaces, with each wireless interface configured to communicate via a particular wireless channel. To illustrate, a first device of the data link group may transmit a first path request message via a first wireless channel using a first wireless interface and may transmit a second path request message via a second wireless channel using a second wireless interface. The first path request message may indicate a first media access control (MAC) address corresponding to the first wireless interface, and the second path request message may indicate a second MAC address corresponding to the second wireless interface. The first path request message and the second path request message may be received and forwarded by one or more devices of the data link group. The one or more devices may include multiple wireless interfaces. To illustrate, a second device may receive the first path request message at a third wireless interface and may forward a first copy of the first path request message to a neighboring device via the first wireless channel using the third wireless interface. Additionally, a second copy of the first path request message may be communicated from the third wireless interface of the second device to a fourth wireless interface of the second device. For example, the second copy of the first path request message may be communicated via a bridge between the wireless interfaces of the second device.

The second device may forward the second copy to a neighboring device via the second wireless channel using the fourth wireless interface. Link metric values indicated by the first path request message may be updated in the first copy of the first path request message based on metrics of a link between the first device and the second device, and the link metric values may be updated in the second copy of the first path request message based on the metrics of the link between the first device and the second device and based on metrics of the bridge between the third wireless interface and the fourth wireless interface. In a particular implementation, the link metric values may be indicated by a link matrix included in a corresponding path request message. The second device may also copy and forward the second path request message in a similar fashion for transmission from the third wireless interface and the fourth wireless interface to other devices of the data link group. For example, the second device may forward the second path request message to a third device that is a destination device for the second path request message.

A destination device may receive multiple copies of the first path request message and multiple copies of the second path request message via the first wireless channel and the second wireless channel at corresponding wireless interfaces of the destination device. The destination device may determine a first path to the first wireless interface of the first device corresponding to a lowest link metric based on information retrieved from the multiple copies of the first path request message, and may cause a first path reply message to be transmitted along the first path to the first wireless interface of the first device. The destination device may also determine a second path to the second wireless interface of the first device corresponding to a lowest link metric based on information retrieved from the multiple copies of the second path request message, and may cause a second path reply message to be transmitted along the second path to the second wireless interface of the first device. The first device may determine whether a first link metric corresponding to the first path reply message or a second link metric corresponding to the second path reply message is lower, and the first device may transmit data to another device along a path identified by the path reply message as having the lower link metric.

In a particular aspect, a method includes generating a first path request message and a second path request message at a first device of a data link group. The first device is configured to communicate via a plurality of wireless channels. The first path request message indicates a first media access control (MAC) address corresponding to a first wireless interface of a plurality of wireless interfaces of the first device. The second path request message indicates a second MAC address corresponding to a second wireless interface of the plurality of wireless interfaces. The method includes transmitting, via a first wireless channel of the plurality of wireless channels, the first path request message from the first wireless interface to a second device (e.g., at least one neighboring device) of the data link group. The method further includes transmitting, via a second wireless channel of the plurality of channels, the second path request message from the second wireless interface to the second device. In a particular aspect, a path through the data link group between the first device and a destination device may traverse multiple wireless channels, thus enabling the data link group to span multiple wireless channels.

In another particular aspect, an apparatus includes message generation logic configured to generate a first path request message and a second path request message, the first path request message indicating a first media access control (MAC) address and the second path request message indicating a second MAC address. The apparatus includes a first wireless interface configured to transmit, via a first wireless channel, the first path request message to a second device of a data link group. The apparatus further includes a second wireless interface configured to transmit, via a second wireless channel, the second path request message to the second device.

In another particular aspect, an apparatus includes means for generating a first path request message and a second path request message at a device. The first path request message indicates a first media access control (MAC) address, and the second path request message indicates a second MAC address. The apparatus includes means for transmitting, via a first wireless channel, the first path request message to at least one neighboring device of a data link group. The apparatus further includes means for transmitting, via a second wireless channel, the second path request message to the at least one neighboring device.

In another particular aspect, a non-transitory computer readable medium stores instructions that, when executed by a processor, cause the processor to generate a first path request message and a second path request message at a device of a data link group. The first path request message indicates a first media access control (MAC) address corresponding to a first wireless interface of the device, and the second path request message indicates a second MAC address corresponding to a second wireless interface of the device. The instructions cause the processor to transmit, via a first wireless channel, the first path request message from the first wireless interface to at least one neighboring device of the data link group. The instructions further cause the processor to transmit, via a second wireless channel, the second path request message from the second wireless interface to the at least one neighboring device.

One advantage provided by at least one of the disclosed aspects is that multiple “intermediate” devices (devices between an originating device and a destination device) include multiple wireless interfaces that are bridged. Devices that have multiple bridged wireless interfaces may exchange messages between wireless channels, thereby increasing a number of possible routes through a data link group. Because multiple devices include bridged wireless interfaces, a particular device of the data link group does not become a bottleneck or a single point of failure because an alternative path through the bridged wireless interfaces of another device may be used. Additionally, a path that utilizes multiple wireless channels may have better link metrics than a path that utilizes a single wireless channel.

Other aspects, advantages, and features of the present disclosure will become apparent after a review of the entire application, including the following sections: Brief Description of the Drawings, Detailed Description, and the Claims.

### IV. BRIEF DESCRIPTION OF THE DRAWINGS

FIG. 1 is a block diagram of a first particular aspect of a system that enables one or more devices (of a data link group) to exchange path request messages over multiple wireless channels;

FIG. 2 illustrates exchange of path reply messages based on the path request messages of FIG. 1;

FIG. 3 is a block diagram of a second particular aspect of a system that enables one or more devices (of a data link group) to exchange path request messages over multiple wireless channels;

FIG. 4 illustrates exchange of path reply messages based on the path request messages of FIG. 3;

FIG. 5 is a block diagram of a particular aspect of a system that enables intermediate devices to selectively forward path request messages;

FIG. 6 illustrates exchange of path reply messages based on the path request messages of FIG. 5;

FIG. 7 is a flow diagram of a first illustrative method of operation at a device (of a data link group);

FIG. 8 is a flow diagram of a second illustrative method of operation at a device (of a data link group);

FIG. 9 is a flow diagram of a third illustrative method of operation at a device (of a data link group); and

FIG. 10 is a block diagram of a wireless device that is operable to support various aspects of one or more methods, systems, apparatuses, and/or computer-readable media disclosed herein.

### VI. DETAILED DESCRIPTION

Particular aspects of the present disclosure are described below with reference to the drawings. In the description, common features are designated by common reference numbers throughout the drawings.

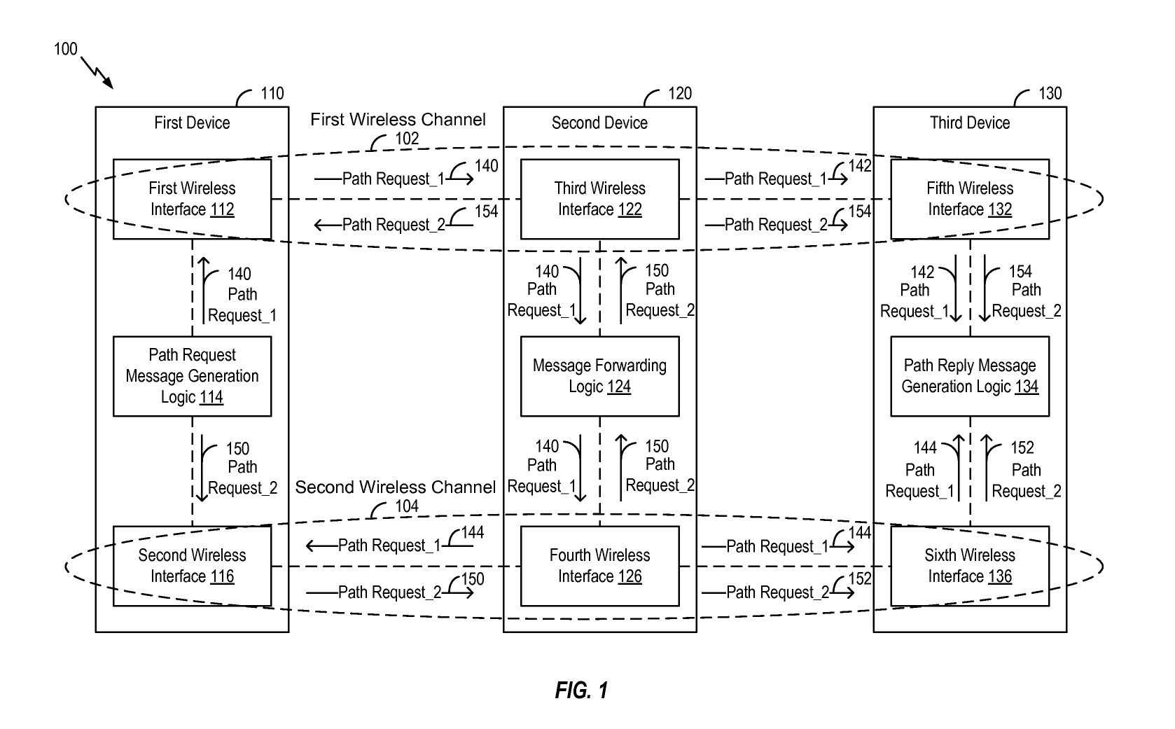

Referring to FIG. 1, a block diagram of a particular aspect of a system 100 that includes one or more devices of a data link group is shown. The system 100 includes a first device 110, a second device 120, and a third device 130. The devices 110, 120, and 130 may be included in one or more “data link groups.” A data link group may also be referred to as a data link, a data link network, a group network, a NAN data link (NDL), a NDL network, a data path group, a data path group network, a NAN data path group, or a NAN data path group network. In some implementations, the data link group may include a mesh network, such as a “social Wi-Fi mesh network” or an Institute of Electrical and Electronics Engineers (IEEE) 802.11s mesh network, as illustrative, non-limiting examples. The data link group may include multiple devices that are able to form a network, such as a decentralized wireless network. Additionally, each device of the data link group may share a type of data announcement, a time corresponding to data announcements (e.g., a paging window), or a combination thereof Additionally, each device of the data link group may use shared security credentials. For example, security information, such as group keys or common network keys, may be shared between the devices of the data link group using wireless communications that are in band or out of band with respect to a group communication channel of the data link group. In some implementations, the devices of the data link group may be synchronized to have periodic wake-up times, such as time periods when each of the devices is awake to advertise a service, to receive traffic or other messages, or a combination thereof Each data link group may correspond to a service provided by one or more of the devices 110, 120, and 130, such as a music service, a social media sharing service, a file sharing service, a data sharing service, or other services. For example, a first service may be provided by a provider device of a first data link group, and a second service may be provided by a provider device of a second data link group.

Additionally, the devices 110, 120, and 130 included in the data link group may be a group of devices (or a subset of the group) included in a neighbor-aware network (NAN). The group of devices in the NAN may be configured to perform association operations, security information exchange operations, synchronization operations, and other operations via one or more wireless channels corresponding to the NAN. The association operations, security information exchange operations, synchronization operations, and other operations may be performed at synchronized times by the group of devices of the NAN. In some implementations, the devices 110, 120, and 130 may perform such operations in accordance with a NAN standard. As part of the data link group, or the NAN, the devices 110, 120, and 130 may perform data exchanges via wireless communications between the devices 110, 120, and 130. For example, data exchanges may be performed without involving wireless carriers, Wi-Fi access points, or the Internet.

The system 100 is illustrated for convenience only and is not limiting. For example, in other implementations, the system 100 may include more than three or fewer than three devices, and the devices may be located at different locations than illustrated in FIG. 1. One or more of the devices 110, 120, and 130 may also be included in other data link groups, other NANs, or a combination thereof

Each of the devices 110, 120, and 130 may be a fixed electronic device or a mobile electronic device. For example, the devices 110, 120, and 130 may include or correspond to mobile phones, laptop computers, tablet computers, multimedia devices, peripheral devices, data storage devices, or a combination thereof. Additionally or alternatively, each of the devices 110, 120, and 130 may include a processor (e.g., a central processing unit (CPU), a digital signal processor (DSP), a network processing unit (NPU), etc.) and a memory (e.g., a random access memory (RAM), a read-only memory (ROM), etc.), which are not illustrated for convenience.

Additionally, the devices 110, 120, and 130 include multiple wireless interfaces configured to communicate via multiple wireless channels. As illustrated in FIG. 1, the first device 110 includes a first wireless interface 112 and a second wireless interface 116, the second device 120 includes a third wireless interface 122 and a fourth wireless interface 126, and the third device 130 includes a fifth wireless interface 132 and a sixth wireless interface 136. The wireless interfaces 112, 116, 122, 126, 132, and 136 may interface with a corresponding wireless receiver and a corresponding wireless transmitter. Although certain operations described herein may be described with reference to a “receiver” or a “transmitter,” in other implementations a transceiver may perform both data receiving and data transmitting operations.

Each of the wireless interfaces 112, 116, 122, 126, 132, and 136 may be configured to send and receive data via a corresponding wireless communication channel. For example, the first wireless interface 112, the third wireless interface 122, and the fifth wireless interface 132 may communicate via a first wireless channel 102, and the second wireless interface 116, the fourth wireless interface 126, and the sixth wireless interface 136 may communicate via a second wireless channel 104. In a particular implementation, the first wireless channel 102 is within a first frequency band and the second wireless channel 104 is within a second frequency band that is different than the first frequency band. For example, the first wireless channel 102 may be within a frequency band that includes a 2.4 giga-hertz (GHz) frequency and the second wireless channel 104 may be within a frequency band that includes a 5 GHz frequency. Such channels may be referred to as “the 2.4 GHz channel” and the “5 GHz channel,” respectively. In other implementations, the first frequency band and the second frequency band are different frequency bands. In an alternate implementation, the first wireless channel 102 and the second wireless channel 104 are different wireless channels within the same frequency band.

The devices 110, 120, and 130 may exchange data, services, or a combination thereof via the first wireless channel 102, the second wireless channel 104, or a combination thereof As used herein, a transmission “via” a particular wireless channel may include, but is not limited to, a “point-to-point” transmission between two devices of the data link group. As another example, a transmission via the particular wireless channel may include a communication that is “broadcast” (e.g., transmitted) from a particular device of the data link group to multiple other devices of the data link group. As used herein, the devices 110, 120, and 130 may be configured to operate in accordance with one or more wireless protocols or standards, such as an Institute of Electrical and Electronics Engineers (IEEE) 802.11 standard. For example, the devices 110, 120, and 130 may operate in accordance with an IEEE 802.11a, b, g, n, s, aa, ac, ad, ae, af, or mc standard. Additionally, the devices 110, 120, and 130 may operate in accordance with a NAN standard or protocol. Additionally, one or more of the devices 110, 120, and 130 may be configured to communicate with a cellular network via a cellular communication protocol or standard, such as a code division multiple access (CDMA) protocol, an orthogonal frequency division multiplexing (OFDM) protocol, an orthogonal frequency division multiple access (OFDMA) protocol, a time division multiple access (TDMA) protocol, a space division multiple access (SDMA) protocol, etc. Additionally, one or more of the devices 110, 120, and 130 may be configured to operate in accordance with a near-field communications standard. Additionally, one or more of the devices 110, 120, and 130 may exchange data via infrared or other near-field communications. Although the devices 110, 120, and 130 are described as including two wireless interfaces and communicating via two wireless channels, such description is for convenience. In other implementations, the devices 110, 120, and 130 may include more than two wireless interfaces and may be configured to communicate via more than two wireless channels. In such implementations, the data link group may span more than two wireless channels.

Each of the devices 110, 120, and 130 may be configured to bridge the respective wireless interfaces. Bridging the wireless interfaces of a particular device may enable the particular device to process data received by one wireless interface and to forward the data, via a bridge (e.g., internal to the particular device), to another wireless interface of the particular device. For example, the first device 110 may bridge the first wireless interface 112 and the second wireless interface 116, the second device 120 may bridge the third wireless interface 122 and the fourth wireless interface 126, and the third device 130 may bridge the fifth wireless interface 132 and the sixth wireless interface 136. In a particular implementation, the devices 110, 120, and 130 may bridge the two wireless interfaces using a software-based bridge. In this implementation, the bridge operates above a MAC layer. In other implementations, any other known bridging technique may be used. A bridging process between wireless interfaces, such as between the first wireless interface 112 and the second wireless interface 116, may emulate a peering process between a device of the data link group and a new device. The peering process may be performed when the new device joins the data link group. Based on this emulated peering, a wireless interface operating on the first wireless channel 102 will appear two hops away from a neighboring device operating on the second wireless channel 104.

The devices 110, 120, and 130 include logic configured to enable the devices 110, 120, and 130 to exchange routing messages via the first wireless channel 102 and the second wireless channel 104. Routing messages may refer to path request messages and path reply messages. As illustrated in FIG. 1, the first device 110 includes path request message generation logic 114, the second device 120 includes message forwarding logic 124, and the third device 130 includes path reply message generation logic 134. The path request message generation logic 114 may be configured to generate multiple path request messages and to provide the multiple path request messages to the first wireless interface 112 and the second wireless interface 116 for transmission to device(s) of the data link group, as further described herein. The message forwarding logic 124 may be configured to receive path request messages from the third wireless interface 122, the fourth wireless interface 126, or a combination thereof, and to cause transmission of copies of the received path request messages from the third wireless interface 122 and the fourth wireless interface 126, as further described herein. The path reply message generation logic 134 may be configured to determine path(s) through the data link group having low, or lowest, corresponding link metrics based on multiple path request messages received at the fifth wireless interface 132 and the sixth wireless interface 136, and to generate and transmit path reply message(s) along the path(s), as further described herein. The illustration in FIG. 1 is for convenience and is not intended to be limiting. For example, each of the devices 110, 120, and 130 may include path request message generation logic 114, message forwarding logic 124, and path reply message generation logic 134.

During operation, the first device 110 may generate data for transmission to the third device 130, such as data related to a service provided by the first device 110 to device(s) of the data link group. To transmit the data, the first device 110 may determine a path across the data link group to the third device 130. As part of determining the path, the path request message generation logic 114 may generate a first path request message 140 (path request_1) and a second path request message 150 (path request_2). The first path request message 140 and the second path request message 150 may be “unique.” For example, a value in a particular field of the first path request message 140 may be different from a corresponding value in the particular field of the second path request message 150. In a particular implementation, the first path request message 140 and the second path request message 150 are Path Request (PREQ) messages generated and formatted in accordance with a hybrid wireless mesh protocol (HWMP) specified by the IEEE 802.11s standard. In an alternate implementation, the first path request message 140 and the second path request message 150 may include more fields (or fewer fields) and different information than a PREQ message formed in accordance with the HWMP specified by the IEEE 802.11s standard. For example, one or more reserved bits in the path request message instead may store bits indicating additional information.

The path request messages 140 and 150 may indicate information corresponding to an originator of the path request messages and a path traversed through the data link group by the path request messages. For example, the first path request message 140 may indicate a first media access control (MAC) address (of an originator of the first path request message 140), a particular sequence number, a first link matrix, a first hop count, first path data, a destination device MAC address, and other information in accordance with the HWMP specified by the IEEE 802.11s standard. The first link matrix may include link metric value(s) corresponding to the path traversed by the first path request message 140, and the first path data may indicate the path traversed by the first path request message 140. The second path request message 150 may indicate a second MAC address, the particular sequence number, a second link matrix, a second hop count, second path data, the destination device MAC address, and other information in accordance with the HWMP specified by the IEEE 802.1 is standard. The first path request message 140 and the second path request message 150 have the same sequence number to indicate that both path request messages correspond to a single overall path determination, and the first path request message 140 and the second path request message 150 indicate the same destination device.

To differentiate between the first wireless interface 112 and the second wireless interface 116 as originators of the first path request message 140 and the second path request message 150, the first MAC address and the second MAC address are different MAC addresses. In a particular implementation, the first MAC address and the second MAC address may be related. For example, the first MAC address and the second MAC address may be based on or derived from a common MAC address, such as a MAC address of the first device 110. Additionally or alternatively, the first path request message 140 and the second path request message 150 may include information that enables other devices to determine that the first MAC address and the second MAC address correspond to different wireless interfaces of the same device (e.g., the first device 110). For example, the first path request message 140, the second path request message 150, or both may include a token that indicates that the first path request message 140, the second path request message 150, or both corresponds to the first device 110.

The first device 110 and the path request message generation logic 114 may cause the first path request message 140 to be transmitted, via the first wireless channel 102, from the first wireless interface 112 to a destination device. In a particular implementation, the destination device (the third device 130) is not a neighboring device of the first device 110, and the first path request message 140 is forwarded to the destination device by at least one device, such as an “intermediate” device (the second device 120) of the data link group. For example, the first path request message 140 may be a “broadcast” message that is transmitted from the first wireless interface 112 and that is capable of being received by multiple neighboring devices of the first device 110 and forwarded by the multiple neighboring devices to the destination device (or to other neighboring devices). To further illustrate, the broadcast message may be transmitted within a particular transmission range of the first device 110, and any devices within the particular transmission range may receive the broadcast message. In an alternate implementation, the destination device may be the neighboring device, and the first path request message 140 may be transmitted from the first device 110 to the destination device via the first wireless channel 102. Additionally, the first device 110 and the path request message generation logic 114 may cause the second path request message 150 to be transmitted, via the second wireless channel 104, from the second wireless interface 116 to the destination device via the at least one device of the data link group. For example, the second path request message 150 may be a broadcast message that is transmitted from the second wireless interface 116 to a neighboring device of the first device 110.

After the first path request message 140 and the second path request message 150 are transmitted, the second device 120 receives the first path request message 140, via the first wireless channel 102, at the third wireless interface 122. Additionally, the second device 120 receives the second path request message 150, via the second wireless channel 104, at the fourth wireless interface 126.

The message forwarding logic 124 of the second device 120 may forward a first copy 142 of the first path request message 140, via the first wireless channel 102, from the third wireless interface 122 to at least one other device of the data link group. For example, the first copy 142 may be forwarded to the third device 130. The first copy 142 of the first path request message 140 may indicate the first MAC address (corresponding to the first wireless interface 112), the particular sequence number, a first updated link matrix, a first updated hop count, updated first path data, the destination device MAC address (corresponding to the third device 130), and the other information of the first path request message 140. Additionally, the message forwarding logic 124 may forward the first path request message 140, via the bridge, from the third wireless interface 122 to the fourth wireless interface 126. After forwarding the first path request message 140, the message forwarding logic 124 may forward a second copy 144 of the first path request message 140, via the second wireless channel 104, to at least one other device of the data link group. For example, the second copy 144 may be forwarded to the third device 130. The second copy 144 of the first path request message 140 may indicate the first MAC address (corresponding to the first wireless interface 112), the particular sequence number, a second updated link matrix, a second updated hop count, updated first path data, the destination device MAC address (corresponding to the third device 130), and the other information of the first path request message 140.

The updated values in the copies 142 and 144 of the first path request message 140 may be updated to indicate the path traversed by the copies 142 and 144, respectively. For example, the message forwarding logic 124 may increment the first hop count by one to generate the first updated hop count. The first updated hop count indicates that the first path request message 140 “hopped” from the first wireless interface 112 to the third wireless interface 122. The message forwarding logic 124 may also update the first link matrix based on a first link metric corresponding to a link between the first device 110 and the second device 120, via the first wireless channel 102, to generate the first updated link matrix. As described above, the first link matrix may indicate one or more link metric values corresponding to the path traversed by the first path request message 140. The first link matrix may be initialized to an initial value by the path request message generation logic 114 of the first device 110 when the first path request message 140 is generated. The second device 120 may determine a link metric value corresponding to the link between the first device 110 and the second device 120 via the first wireless channel 102. For example, the link metric value may include or correspond to a measure of a bit error rate (BER), a utilization of the link by one of the devices, a “link weight,” other measurements, or a combination thereof The link metric value corresponding to the link between the first device 110 and the second device 120 may be added to the initial link matrix value, such that the updated link matrix in the first copy 142 of the first path request message 140 represents a cumulative link matrix as the first path request message 140 propagates through the data link group.

Because the second copy 144 of the first path request message 140 traversed the bridge between the third wireless interface 122 and the fourth wireless interface 126, the updated values of the second copy 144 may be different than the updated values of the first copy 142. For example, the message forwarding logic 124 may increment the first hop count by two to generate the second updated hop count. The second updated hop count indicates that the first path request message 140 “hopped” from the first wireless interface 112 to the third wireless interface 122 and from the third wireless interface 122 to the fourth wireless interface 126. The message forwarding logic 124 may also update the first link matrix based on the first link metric corresponding to the link between the first device 110 and the second device 120 and based on a second link metric corresponding to the bridge between the third wireless interface 122 and the fourth wireless interface 126 to generate the second updated link matrix. Thus, a forwarded path request message that is bridged from between two wireless interfaces of a device (and that changes wireless channels) appears to other devices to have hopped across two devices based on the updated hop count and the updated link matrix.

Additionally, the message forwarding logic 124 may forward a first copy 152 of the second path request message 150, via the second wireless channel 104, from the fourth wireless interface 126 to at least one other device of the data link group, and may forward a second copy 154 of the second path request message 150, via the first wireless channel 102, from the third wireless interface 122 to at least one other device of the data link group. The first copy 152 of the second path request message 150 may indicate the second MAC address (corresponding to the second wireless interface 116), the particular sequence number, a third updated link matrix, a third updated hop count, updated second path data, the destination device MAC address (corresponding to the third device 130), and the other information of the second path request message 150. The second copy 154 of the second path request message 150 may indicate the second MAC address, the particular sequence number, a fourth updated link matrix, a fourth updated hop count, updated second path data, the destination device MAC address, and the other information of the second path request message 150. The message forwarding logic 124 may increment the second hop count by one to generate the third updated hop count. The third updated hop count indicates that the second path request message 150 “hopped” from the second wireless interface 116 to the fourth wireless interface 126. The message forwarding logic 124 may also update the second link matrix based on a third link metric corresponding to a link between the first device 110 and the second device 120, via the second wireless channel 104, to generate the third updated link matrix. Additionally, the message forwarding logic 124 may increment the second hop count by two to generate the fourth updated hop count. The fourth updated hop count indicates that the second path request message 150 “hopped” from the second wireless interface 116 to the fourth wireless interface 126 and from the fourth wireless interface 126 to the third wireless interface 122. The message forwarding logic 124 may also update the second link matrix based on the third link metric corresponding to the link between the first device 110 and the second device 120 and based on the second link metric corresponding to the bridge between the third wireless interface 122 and the fourth wireless interface 126 to generate the fourth updated link matrix.

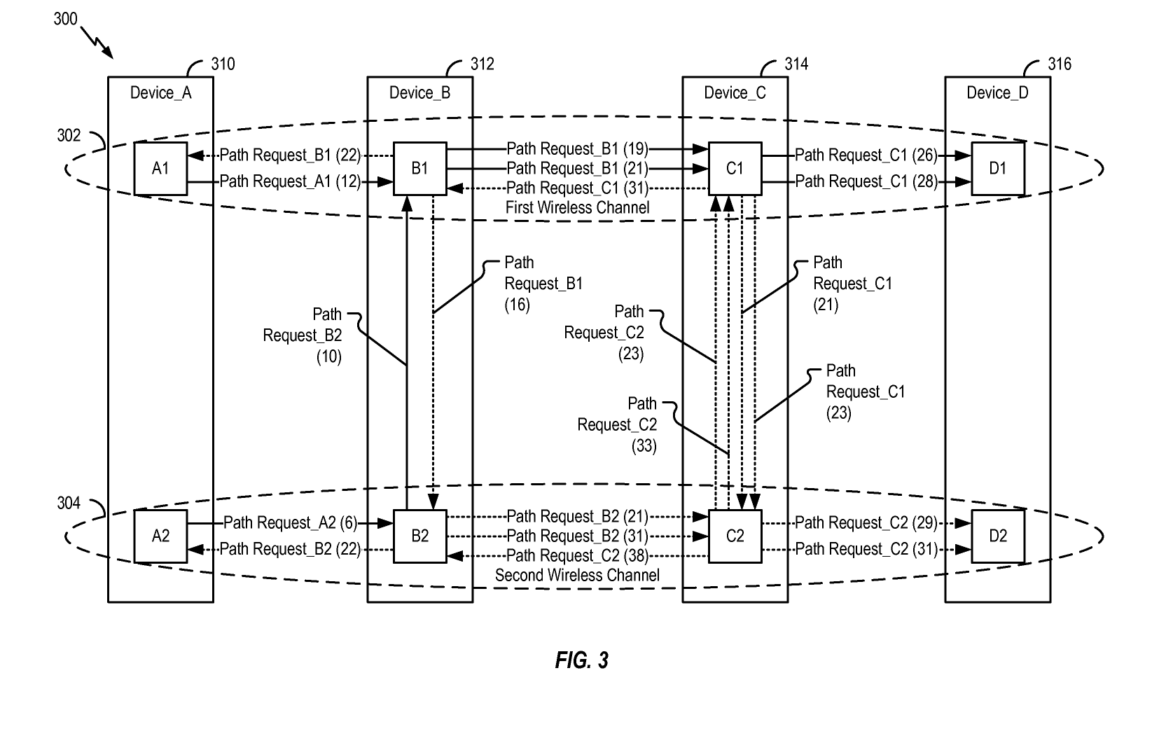

In a particular implementation, the message forwarding logic 124 selectively forwards additional copies of the first path request message 140 or the second path request message 150 based on a corresponding link matrix. For example, the second device 120 may receive, via the first wireless channel 102, an additional copy of the first path request message 140 at the third wireless interface 122 after forwarding the first copy 142 of the first path request message 140 and the second copy 144 of the first path request message 140. The message forwarding logic 124 may compare a second link metric value (from a link matrix) indicated by the additional copy of the first path request message 140 to a first link metric value from the first link matrix indicated by the first path request message 140. If the second link metric value is less than or equal to the first link metric value, the message forwarding logic 124 may forward copies of the additional copy of the first path request message 140 using the third wireless interface 122 and the fourth wireless interface 126. If the second link metric value exceeds the first link metric value, the message forwarding logic 124 may suppress forwarding of the additional copy of the first path request message 140. Such selective forwarding and suppression is further described with reference to FIG. 3.

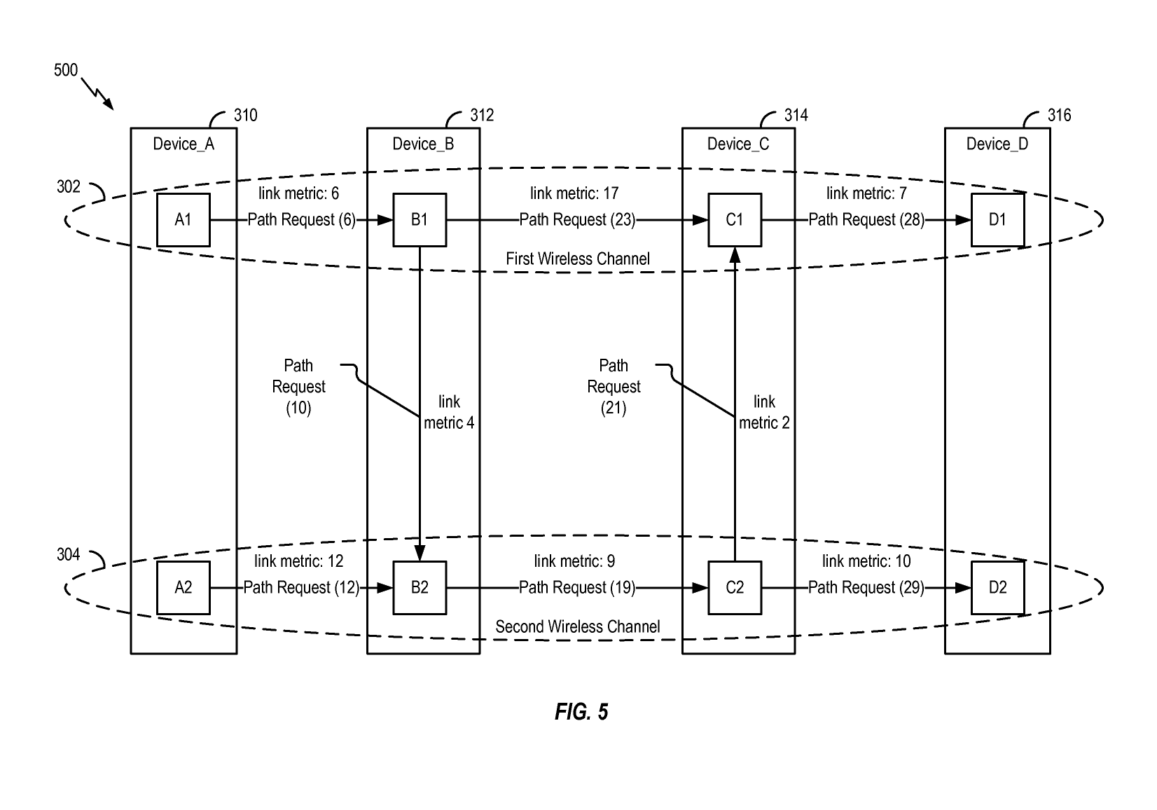

In another particular implementation, the message forwarding logic 124 selectively suppresses transmission of a particular path request message based on determining that the message forwarding logic 124 has already forwarded a copy of a particular path request message. For example, the second device 120 may receive, via the first wireless channel 102, a particular path request message at the third wireless interface 122 after forwarding the first copy 142 of the first path request message 140 and the second copy 144 of the first path request message 140. The message forwarding logic 124 may determine whether the particular path request message corresponds to the first copy 142 or the second copy 144. For example, the message forwarding logic 124 may determine whether the particular path request message is a forwarded copy of a path request message that was originally forwarded by the second device 120, either at the third wireless interface 122 or the fourth wireless interface 126. If the message forwarding logic 124 determines that the particular path request message corresponds to the first copy 142 or the second copy 144, forwarding of the particular path request message is suppressed. If the message forwarding logic 124 determines that the particular path request message does not correspond to the first copy 142 or the second copy 144, copies of the particular path request message are forwarded from the third wireless interface 122 and the fourth wireless interface 126. Such selective suppression is further described with reference to FIG. 5.

In another particular implementation, the message forwarding logic 124 may suppress transmission of path request messages from a same device that are received at different wireless interfaces of the second device 120. For example, the message forwarding logic 124 may compare the first path request message 140 and the second path request message 150 to determine whether the path request messages 140 and 150 were generated by the same device. In a particular implementation, the message forwarding logic 124 may determine whether the first MAC address and the second MAC address are based on a common MAC address. Additionally or alternatively, the message forwarding logic 124 may determine whether the path request messages 140 and 150 were generated by the same device based on a first token in the first path request message, a second token in the second path request message, or both. Responsive to determining that the path request messages 140 and 150 were generated by the same device (e.g., the first device 110), the message forwarding logic 124 may compare a first link metric (in the first link matrix) indicated by the first path request message 140 to a second link metric (in the second link matrix) indicated by the second path request message 150. If the first link metric exceeds the second link metric, the message forwarding logic 124 may forward copies of the second path request message 150 and may suppress forwarding of the first path request message 140. If the second link metric exceeds the first link metric, the message forwarding logic 124 may forward copies of the first path request message 140 and may suppress forwarding of the second path request message 150. If the first link metric and the second link metric are the same, copies of both path request messages 140 and 150 may be forwarded to the data link group.

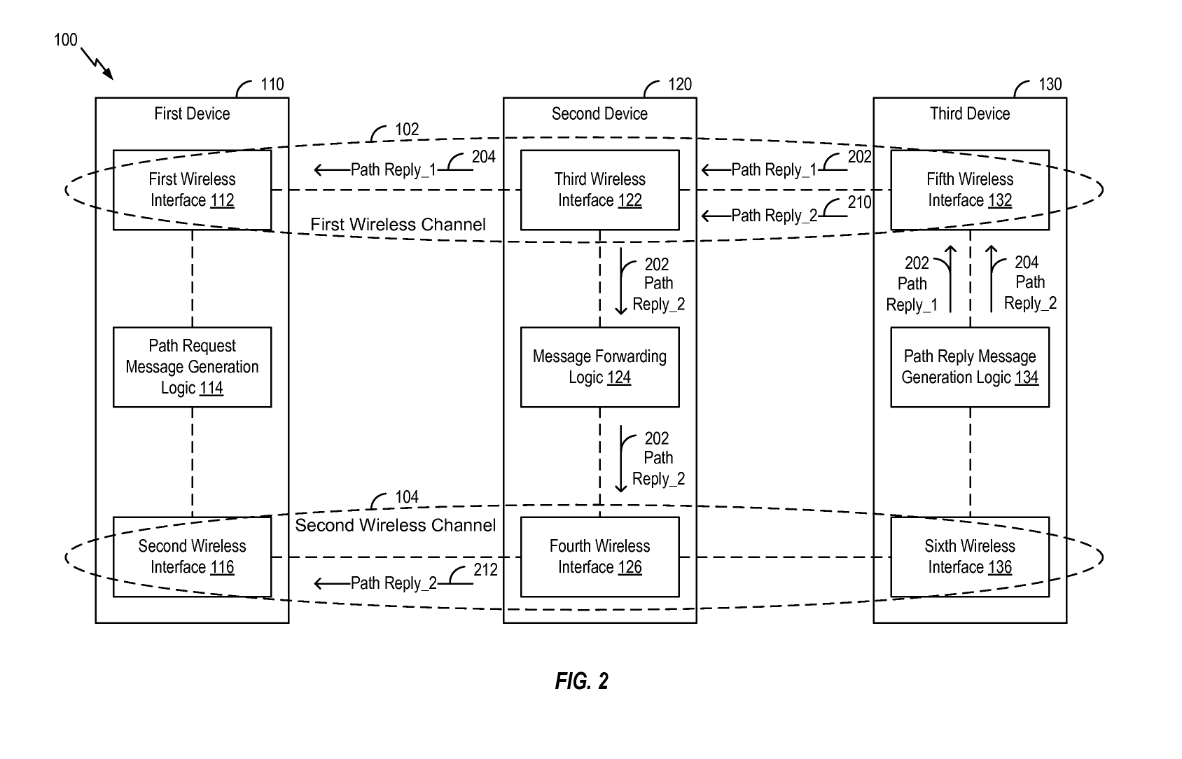

After propagating through the data link group, the forwarded copies of the first path request message 140 and the second path request message 150 may be received by the third device 130 (e.g., the destination device). For example, the first copy 142 of the first path request message 140 and the second copy 154 of the second path request message 150 may be received, via the first wireless channel 102, at the fifth wireless interface 132, and the second copy 144 of the first path request message 140 and the first copy 152 of the second path request message 150 may be received, via the second wireless channel 104, at the sixth wireless interface 136. The first copy 142 of the first path request message 140, the second copy 144 of the first path request message 140, the first copy 152 of the second path request message 150, and the second copy 154 of the second path request message 150 may be provided to the path reply message generation logic 134 for processing and generating path reply messages, as described with reference to FIG. 2.

It is noted that various functions performed by the system 100 of FIG. 1 have been described as being performed by separate components or modules. Such description (and illustration in FIG. 1) is for ease of explanation and is not limiting. Each of the components may be integrated within a processor. For example, a processor may be configured to perform operations described with reference to the path request message generation logic 114, the message forwarding logic 124, and the path reply message generation logic 134.

The division of components (or elements) illustrated in FIG. 1 is for illustration only. In an alternate aspect, a function performed by a particular component may be divided amongst multiple components. Moreover, in an alternate aspect, two or more components of FIG. 1 may be integrated into a single component. In an alternate aspect, each of the path request message generation logic 114, the message forwarding logic 124, and the path reply message generation logic 134 may be distinct elements. Each component or module illustrated in FIG. 1, such as the path request message generation logic 114, the message forwarding logic 124, and the path reply message generation logic 134, may be implemented using hardware (e.g., a field-programmable gate array (FPGA) device, an application-specific integrated circuit (ASIC), a digital signal processor (DSP), a controller, etc.), software (e.g., instructions executable by a processor), or any combination thereof.

One advantage provided by the system 100 is path request messages corresponding to a single data link group may be transmitted via multiple wireless channels. A path through the data link group determined based on the path request messages may be more flexible and have a lower link metric value than a path between a first single-channel data link group and a second single-channel data link group through a fixed bridge device.

FIG. 2 illustrates exchange of path reply messages between devices based on the path request messages of FIG. 1. In FIG. 2, after receiving the first copy 142 of the first path request message 140, the second copy 144 of the first path request message 140, the first copy 152 of the second path request message 150, and the second copy 154 of the second path request message 150, the path reply message generation logic 134 of the third device 130 may determine a first path through the data link group between the third device 130 and the first wireless interface 112 of the first device 110 and the path reply message generation logic 134 may determine a second path through the data link group between the third device 130 and the second wireless interface 116 of the first device 110. The first path and the second path may be selected to correspond to a lowest metric value indicated by the copies of the path request messages 140 and 150.

The path reply message generation logic 134 may compare link metric values corresponding to copies of the same path request message received at different wireless interfaces to determine the first path and the second path. For example, the path reply message generation logic 134 may compare a first link metric value in the first updated link matrix indicated by the first copy 142 of the first path request message 140 received at the fifth wireless interface 132 to a second link metric value in the second updated link matrix indicated by the second copy 144 of the first path request message 140 received at the sixth wireless interface 136. If the first link metric value exceeds the second link metric value, the path reply message generation logic 134 may select the first path based on the updated path data indicated in the second copy 144. For example, the path traversed by the second copy 144 through the data link group may be selected as the first path (to the first wireless interface 112). If the first link metric value does not exceed the second link metric value, the path reply message generation logic 134 may select the first path based on the updated path data indicated in the first copy 142. For example, the path traversed by the first copy 142 through the data link group may be selected as the first path (to the first wireless interface 112). Similarly, the path reply message generation logic 134 may select one of the path traversed by the first copy 152 of the second path request message 150 and the path traversed by the second copy 154 of the second path request message 150 as the second path (to the second wireless interface 116), based on a comparison of link metric values indicated by the first copy 152 and the second copy 154.

The path reply message generation logic 134 may generate a first path reply message 202 (path reply_1) for transmission along the first path and a second path reply message 210 (path reply_2) for transmission along the second path. The first path reply message 202 and the second path reply message 210 may include MAC addresses indicating a particular wireless interface of the third device 130, hop counts, link matrices, and other information similar to the path request messages 140 and 150 of FIG. 1. In a particular implementation, the first path reply message 202 and the second path reply message 210 are Path Reply (PREP) messages that are formatted in accordance with the HWMP specified by the IEEE 802.11s standard. The first path reply message 202 and the second path reply message 210 may be provided to particular wireless interface (e.g., either the fifth wireless interface 132 or the sixth wireless interface 136) that is part of the respective path. For example, as illustrated in FIG. 2, the first path and the second path include the fifth wireless interface 132. In this example, the path reply message generation logic 134 provides the first path reply message 202 and the second path reply message 210 to the fifth wireless interface 132 and the first path reply message 202 and the second path reply message 210 are transmitted, via the first wireless channel 102, to device(s) of the data link group. In other examples, if one of the first path or the second path includes the sixth wireless interface 136, the first path reply message 202 or the second path reply message 210 may be provided to the sixth wireless interface 136 for transmission to device(s) of the data link group.

The second device 120 may receive the first path reply message 202 and the second path reply message 210, via the first wireless channel 102, at the third wireless interface 122. The message forwarding logic 124 may forward a copy 204 of the first path reply message 202, via the first wireless channel 102, from the third wireless interface 122 to the data link group. Additionally, the message forwarding logic 124 may forward the second path reply message 210, via the bridge, to the fourth wireless interface 126 and may transmit a copy 212 of the second path reply message 210, via the second wireless channel 104, from the fourth wireless interface 126 to the data link group. Hop counts, link matrices, and path data may be updated in a similar manner to the updated hop counts, link matrices, and path data of the path request messages, as described with reference to FIG. 1.

After propagation through the data path (along the corresponding path), the first device 110 may receive the copy 204 of the first path reply message 202, via the first wireless channel 102, at the first wireless interface 112, and may receive the copy 212 of the second path reply message 210, via the second wireless channel 104, at the second wireless interface 116. The first device 110 may determine a particular path through the data link group between the first device 110 and the third device 130 from the first path corresponding to the first path reply message 202 and the second path corresponding to the second path reply message 210. The particular path may be determined based on link metric values indicated by the copy 204 of the first path reply message 202 and the copy 212 of the second path reply message 210. For example, the first device may compare a first link metric (in the updated link matrix) indicated by the copy 204 to a second link metric (in the updated link matrix) indicated by the copy 212. If the first link metric does not exceed the second link metric, the first path (corresponding to the first path reply message 202) may be selected as the particular path. If the first link metric exceeds the second link metric, the second path (corresponding to the second path reply message 210) may be selected as the particular path. After selection of the particular path, data may be transmitted from the first device 110 along the particular path through the data link group to the third device 130.

In a particular implementation, the first device 110 (e.g., the originator device) receives a path reply message for each transmitted path request message. Alternatively, intermediate devices such as the second device 120 are configured to suppress multiple messages from the same device. In this alternate implementation, the first device 110 may receive a single path reply message because the third device 130 received multiple copies of a single path request message, and the first device 110 may transmit data along a path indicated by the single path reply message. In this implementation, path selection is not performed.

In another particular implementation, the path request messages 140 and 150 may include a “target only” (TO) flag. If the TO flag is asserted, the destination device (e.g., the third device 130) is the only device that will transmit path reply messages in response to the path request messages 140 and 150. If the TO flag is de-asserted, an intermediate device such as the second device 120 may transmit a path reply message in response to the path request message if the intermediate device has a “fresher” route than a previous route that the first device 110 has. For example, when a route between two devices in the data link group is formed, the route may correspond to a route identifier (ID). The route ID may be based on an atomically incremented number, such that a route with a higher route ID is a more recently formed than a route with a lower route ID. In a particular implementation, the route IDs may be generated in accordance with the HWMP specified by the IEEE 802.11s standard. If the first device 110 has already formed a previous route and is attempting to form a new route, the path request messages 140 and 150 may indicate the route ID of the previous route. When the second device 120 receives the path request messages 140 and 150 and determines that the second device 120 has a route to the third device 130 that corresponds to a higher route ID than the route ID of the previous route indicated in the path request messages 140 and 150, the second device 120 may transmit one or more path reply messages to the first device 110 via the first wireless channel 102, the second wireless channel 104, or both.

One advantage provided by the path reply message exchange described in FIG. 2 is that path reply messages corresponding to a single data link group may be transmitted via multiple wireless channels. A path through the data link group determined based on the path reply messages may be more flexible and have a lower link metric value than a path between a first single-channel data link group and a second single-channel data link group through a fixed bridge device.

Referring to FIG. 3, a block diagram of a second particular aspect of a system 300 that enables devices included in a data link group to exchange path request messages is shown. The system 300 includes a first device 310 (Device_A), a second device 312 (Device_B), a third device 314 (Device_C), and a fourth device 316 (Device_D). The devices 310-316 may include or correspond to the devices 110, 120, and 130 of FIG. 1. In FIG. 3, the devices 310-316 are part of a data link group. The first device 310 includes wireless interfaces A1 and A2, the second device 312 includes wireless interfaces B1 and B2, the third device 314 includes wireless interfaces C1 and C2, and the fourth device 316 includes wireless interfaces D1 and D2. Wireless interfaces A1, B1, C1, and D1 are configured to communicate via a first wireless channel 302, and wireless interfaces A2, B2, C2, and D2 are configured to communicate via a second wireless channel 304. The wireless interfaces of each device are bridged. For example, wireless interfaces A1 and A2 are bridged, wireless interfaces B1 and B2 are bridged, wireless interfaces C1 and C2 are bridged, and wireless interfaces D1 and D2 are bridged).

Each of the devices 310-316 may include the path request message generation logic 114, the message forwarding logic 124, and the path reply message generation logic 134, as described with reference to FIG. 1. In FIG. 3, link metric values for each link between two wireless interfaces via a wireless channel (or between two wireless interfaces across a corresponding bridge) are illustrated as numbers. In FIG. 3, path request messages are designated path request_X (Y), where X represents the wireless interface that transmitted the path request message, and Y represents a cumulative link metric value from the originator to the recipient of the path request message. For example, path request (21) represents a path request message transmitted by wireless interface B1 having a cumulative link metric value of 21 from the originator (wireless interface A1) to the recipient (wireless interface CO.

As illustrated in FIG. 3, the first device 310 may operate as an originator device and may generate multiple path request messages and transmit the multiple path request messages via the multiple wireless channels 102 and 104, the second device 312 and the third device 314 may selectively forward path request request messages, and the fourth device 316 may operate as a destination device and may receive multiple path request messages via the multiple wireless channels 102 and 104. In FIG. 3, path request messages illustrated with a solid line represent path request messages that are exchanged along the paths between wireless interface A1 (or wireless interface A2) and the fourth device 316 that have the lowest cumulative link metric, and path request messages illustrated with a dotted line represent path request messages that are exchanged along paths that do not have the lowest cumulative link metric. Such illustration is for convenience, and the determination of the path(s) having the lowest cumulative link metric may occur at the fourth device 316 after receipt of the multiple path request messages illustrated in FIG. 3.

The devices 310-316 may suppress path request messages corresponding to path request messages that have been previously forwarded by a different wireless interface of the same device. For example, wireless interface B1 may transmit path request_B1 (21) to wireless interface C1, which may be forwarded to wireless interface C2 as path request_C1 (23), which may be further forwarded to wireless interface B2 as path request_C2 (38). The second device may determine that path request_C2 (38) corresponds to path request_B1 (21), which was previously transmitted by a different wireless interface (B1) of the same device, and may suppress forwarding of path request_C2 (38). To further illustrate, path request_B1 (22), path request_B2 (22), and path request_C1 (31) are suppressed the recipient devices.

Additionally, the devices may suppress path request messages having a particular originator (as indicated by an originator MAC address) and a higher link metric value than a previously forwarded path request message having the same originator. For example, wireless interface C2 may receive path request message path request_C1 (23) and path request message path request_B2 (31), having the same originator (wireless interface A1). Wireless interface C2 may forward the first received path request message and may selectively forward the second received path request message based on the corresponding link metric value. For example, if path request_C1 (23) is the first received path request message, path request_C1 (23) may be forwarded, and path request_B2 (31) may be suppressed because the link metric value of 31 exceeds the link metric value of 23. As another example, if path request_B2 (31) is the first received path request message, path request_B2 (31) may be forwarded, and path request_C1 (23) may also be forwarded because the link metric value of 23 does not exceed the link metric value of 31. By selectively forwarding or suppressing path request messages based on prior forwarded path request messages, the devices 310-316 reduce a number of path request messages exchanged in the system 300 as compared to a system where each device forwards each received path request message.

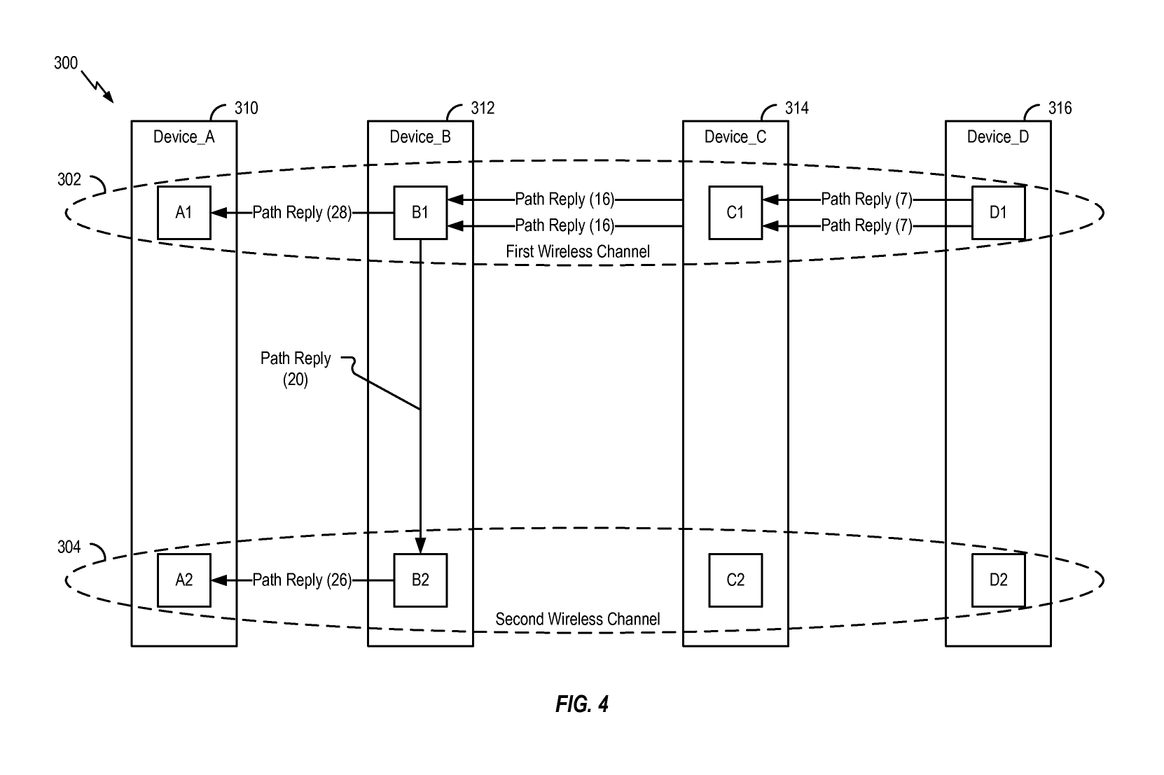

FIG. 4 illustrates exchange of path reply messages based on the path request messages of FIG. 3. In FIG. 4, after receiving the multiple path request messages, the fourth device 316 may determine a first path through the data link group to the wireless interface A1 of the first device 310 and a second path through the data link group to wireless interface A2 of the first device 310. The fourth device 316 may determine a lowest link metric value indicated by the multiple path request messages originating from wireless interface A1, and the fourth device 316 may select the path indicated by the corresponding path request message as the first path. Additionally, the fourth device 316 may determine a lowest link metric value indicated by the multiple path request messages originating from wireless interface A2, and the fourth device 316 may select the path indicated by the corresponding path request message as the second path. As illustrated in FIG. 4, based on the link metric values indicated in FIG. 3, the fourth device 316 selects a path from wireless interface D1 to wireless interface A1, through wireless interfaces C1 and B1, as the first path having a link metric value of 28 (12+9+7). The fourth device 316 transmits a first path reply message to the first device 310 along the first path. Additionally, the fourth device 316 selects a path from wireless interface D1 to wireless interface A2, through wireless interfaces C1, B1, B2, and the bridge between B1 and B2, as the second path having a link metric value of 26 (6+4+9+7). The fourth device 316 transmits a second path reply message to the first device 310 along the second path. The first device 310 may compare the link metric value of first path reply message (28) to the link metric value of the second path reply message (26), and may determine to transmit data to the fourth device 316 via the second path based on the link metric value of the second path reply message (26) being less than the link metric value of the first path reply message (28).

FIG. 5 is a block diagram of a particular aspect of a system 500 that enables intermediate devices to selectively forward path request messages. The system 500 includes the devices 310-316 of FIGS. 3 and 4. In FIG. 5, links between the devices 310-316 have different link metric values than in FIGS. 3 and 4. Additionally, in FIG. 5, the devices 310-316 are configured to selectively forward or suppress messages from a same originating device based on link metric values. For example, the second device 312 may receive a first path request message (path request (10)) from wireless interface B1 at wireless interface B2. The first path request message may be received via the bridge between wireless interfaces B1 and B2. The first path request message may indicate wireless interface A1 as the originator. The second device 312 may forward the first path request message. For example, the first path request message may be the first message received at the wireless interface B2, and the second device 312 forwards the first path request message because the first path request message is a first received path request message. After forwarding the first path request message, the second device 312 may receive a second path request message (path request (12)) at wireless interface B2. The second path request message may indicate wireless interface A2 as the originator. The second device 312 may determine whether the originator of the first path request message is the same as the originator of the second path request message. For example, the second device 312 may determine whether the originator of the first path request message is the originator of the second path request message based on MAC addresses or tokens in the path request messages, as described with reference to FIG. 1. If the second device 312 determines that the first path request message and the second path request message have the same originating device (the first device 310 in the example illustrated in FIG. 5), the second device 312 may selectively forward (or suppress) the second path request message based on a first link metric value of the first path request message and a second link metric value of the second path request message. To illustrate, if the second link metric value exceeds the first link metric value, the second device 312 suppresses the second path request message. As illustrated in FIG. 5, the second link metric value is 12 and the first link metric value is 10 (6+4), so the second device 312 suppresses the second path request message. In an alternate example (not shown), if the second link metric value does not exceed the first link metric value, the second device 312 forwards the second path request message. By selectively forwarding or suppressing path request messages having the same originating device, the path request message forwarding illustrated in FIG. 5 may reduce a number of path request messages exchanged as compared to the system 300 of FIG. 3.

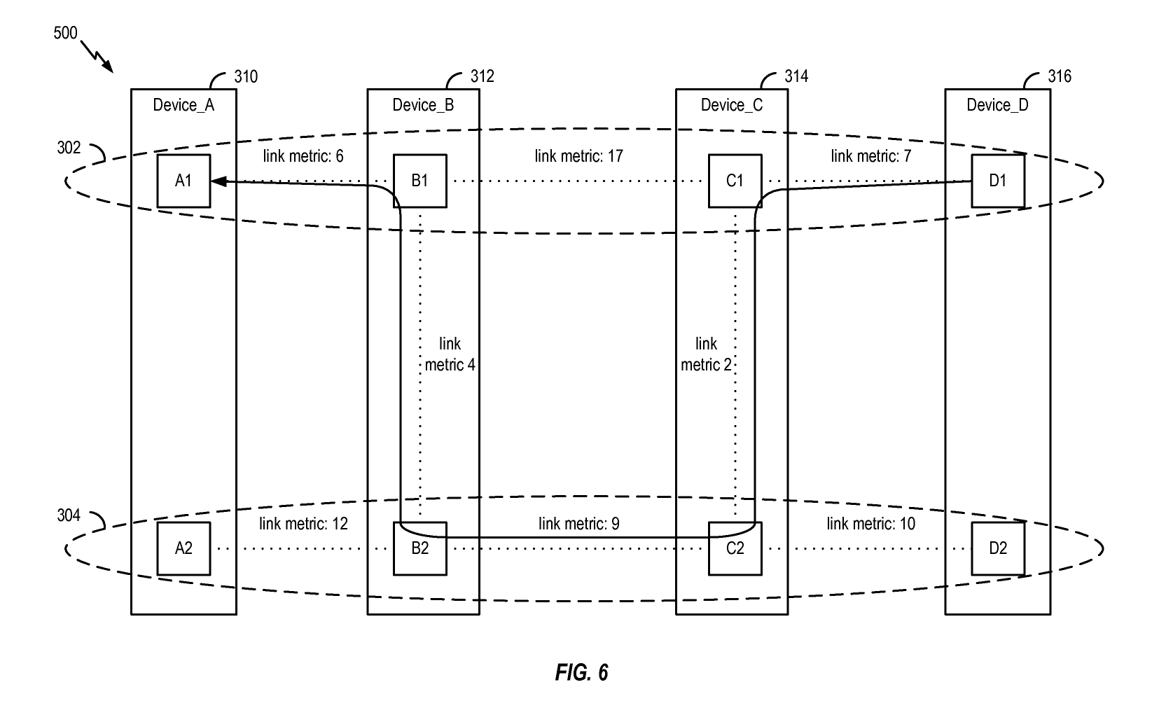

FIG. 6 illustrates exchange of path reply messages based on the path request messages of FIG. 5. In FIG. 6, after receiving the multiple path request messages, the fourth device 316 may determine a particular path through the data link group to the wireless interface A1 of the first device 310. The fourth device 316 may determine a lowest cumulative link metric value indicated by the multiple path request messages, and the fourth device 316 may select the path indicated by the corresponding path request message as the particular path. As illustrated in FIG. 6, based on the link metric values indicated in FIG. 5, the fourth device 316 selects a path from wireless interface D1 to wireless interface A1, through wireless interfaces C1, C2, B2, and B1, as the particular path having a link metric value of 28 (7+2+9+4+6). The fourth device 316 transmits a path reply message to the first device 310 along the particular path. After receiving the path reply message, the first device 310 may transmit data to the fourth device 316 along the particular path through the data link group.

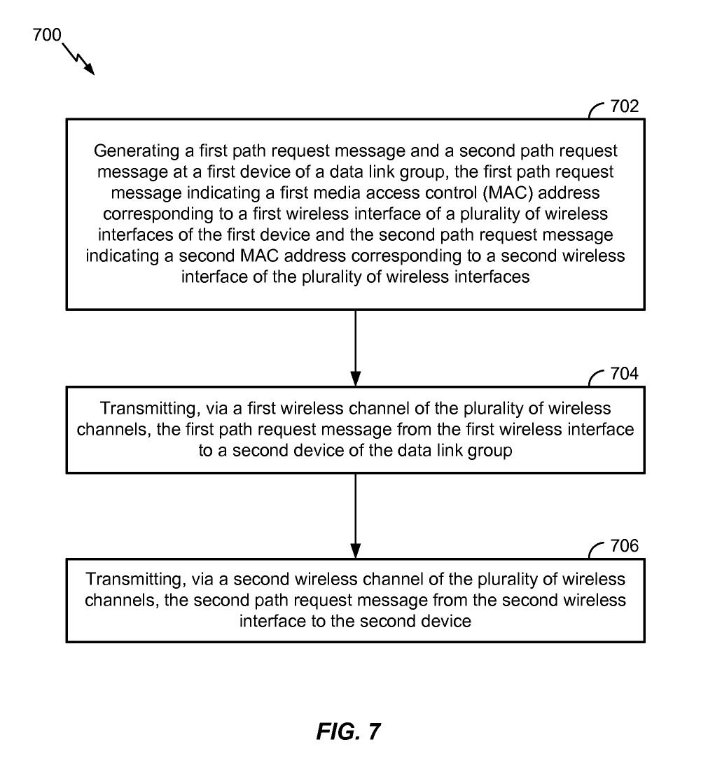

Referring to FIG. 7, a first aspect of a method 700 of operation at a device of a data link group is shown. The method 700 may be performed at any of the devices 110, 120, and 130 of FIG. 1 or any of the devices 310-316 of FIGS. 3-6. In some implementations, steps of the method 700 may be performed in other orders, or one or more steps of the method 700 may be optional (e.g., may not be performed in all implementation).

The method 700 includes generating a first path request message and a second path request message at a first device of a data link group, at 702. The first path request message indicates a first MAC address corresponding to a first wireless interface of a plurality of wireless interfaces of the first device and the second path request message indicates a second MAC address corresponding to a second wireless interface of the plurality of wireless interfaces. For example, with reference to FIG. 1, the path request message generation logic 114 of the first device 110 may generate the first path request message 140 and the second path request message 150.

The method 700 includes transmitting, via a first wireless channel, the first path request message from the first wireless interface to a second device of the data link group, at 704. For example, with reference to FIG. 1, the first path request message 140 may be transmitted, via the first wireless channel 102, from the first wireless interface 112 to the second device 120 (and to other neighboring devices of the data link group).

The method 700 further includes transmitting, via a second wireless channel, the second path request message from the second wireless interface to the second device, at 706. For example, with reference to FIG. 1, the second path request message 150 may be transmitted, via the second wireless channel 104, from the second wireless interface 116 to the second device 120. The first wireless interface and the second wireless interface may be bridged by a bridging process, as described with reference to FIG. 1.

The first path request message and the second path request message may indicate a destination MAC address of a destination device. In a particular implementation, the destination device is different than the second device. For example, with reference to FIG. 1, the destination device is the third device 130, which is different than the second device 120 to which the first path request message 140 and the second path request message 150 are sent. In an alternate implementation, the destination device is the second device. In this implementation, the destination device is a neighboring device of the first device in the data link group.

In a particular implementation, the method 700 further includes generating a third path request message at the first device. The third path request message indicates a third MAC address corresponding to a third wireless interface of the plurality of wireless interfaces. For example, with reference to FIG. 1, the path request message generation logic 114 of the first device 110 may generate a third path request message. The method 700 also includes transmitting, via a third wireless channel of the plurality of wireless channels, the third path request message from the third wireless interface to the second device. For example, with reference to FIG. 1, the third path request message may be transmitted to the second device 120 via a third wireless channel (not shown).

In a particular implementation, the first wireless channel is within a first frequency band, the second wireless channel is within a second frequency band, and the second frequency band is different than the first frequency band. For example, the first wireless channel 102 and the second wireless channel 104 may be in different frequency bands. In an alternative implementation, the first wireless channel and the second wireless channel are different wireless channels within the same frequency band. For example, the first wireless channel 102 and the second wireless channel 104 may be different wireless channels within the same frequency band.

In a particular implementation, the first path request message indicates a particular sequence number, a first link matrix, and a first hop count, and the second path request message indicates the particular sequence number, a second link matrix, and a second hop count. Additionally or alternatively, the first path request message and the second path request message are Path Request (PREQ) messages generated in accordance with a hybrid wireless mesh protocol (HWMP) specified by an Institute of Electrical and Electronics Engineers (IEEE) 802.11s standard. Additionally or alternatively, the first MAC address and the second MAC address are different MAC addresses, as described with reference to FIG. 1. In a particular implementation, the first MAC address and the second MAC address are derived from a particular MAC address corresponding to the first device. Alternatively, the first MAC address corresponds to the first device, and the second path request message includes a token, the token indicating the second path request message corresponds to the first device, as described with reference to FIG. 1. Additionally or alternatively, the data link group includes a plurality of devices of a neighbor aware network (NAN). For example, the devices 110, 120, and 130 of the data link group may also be part of a NAN.

In a particular implementation, the method 700 includes receiving, via the first wireless channel, a first path reply message at the first wireless interface. The first path reply message indicates a first path through the data link group between the first device and a destination device. For example, with reference to FIG. 2, the first device 110 may receive, via the first wireless channel 102, the copy 204 of the first path reply message 202 at the first wireless interface 112. The copy 204 indicates the first path through the data link group between the first wireless interface 112 and the fifth wireless interface 132. The method 700 further includes receiving, via the second wireless channel, a second path reply message at the second wireless interface. The second path reply message indicates a second path through the data link group between the first device and the destination device. For example, with reference to FIG. 2, the first device 110 may receive, via the second wireless channel 104, the copy 212 of the second path reply message 210 at the second wireless interface 116. The copy 212 indicates the second path through the data link group between the second wireless interface 116 and the fifth wireless interface 132. The first path, the second path, or both, may traverse the data link group via multiple wireless channels and may include multiple devices of the data link group. For example, with reference to FIG. 2, the second path includes the first device 110, the second device 120, and the third device 130, and traverses the first wireless channel 102 and the second wireless channel 104. Additionally, the first path reply message and the second path reply message may be Path Reply (PREP) messages generated in accordance with a hybrid wireless mesh protocol (HWMP) specified by an Institute of Electrical and Electronics Engineers (IEEE) 802.11s standard.

Additionally, the method 700 may include determining a particular path based on a comparison of a first link metric corresponding to the first path and a second link metric corresponding to the second path and transmitting a data packet from the first device to at least one other device along the particular path. For example, with reference to FIG. 2, the first device 110 may determine link metric values corresponding to the first path and the second path, and may transmit data to the third device 130 to along the path having the lower link metric value. The particular path may traverse multiple wireless interfaces of the second device. For example, with reference to FIG. 2, the particular path (e.g., the second path) may traverse the third wireless interface 122 and the fourth wireless interface 126 of the second device 120.

Additionally, the method 700 may include comparing the first link metric of a first link matrix indicated by the first path reply message to the second link metric of a second link matrix indicated by the second path reply message. The first link metric corresponds to the first path, and the second link metric corresponds to the second path. For example, with reference to FIG. 4, the first device 310 compares the first link metric (28) corresponding to the first path to the second link metric (26) corresponding to the second path. The method 700 may further include selecting the first path as the particular path if the first link metric is less than or equal to the second link metric and selecting the second path as the particular path if the first link metric exceeds the second link metric. For example, based on determining that the first link metric exceeds (28) the second link metric (26), the first device 310 selects the second path for transmitting data.

In another particular implementation, the method 700 includes receiving a path reply message at a particular wireless interface. The particular wireless interface is one of the first wireless interface and the second wireless interface, and the path reply message indicates a particular path through the data link group between the first device and a destination device. For example, with reference to FIG. 6, the first device 310 receives the path reply message at the wireless interface A1. The path reply message indicates the path through the data link group between the wireless interface A1 and the wireless interface D1. The method 700 further includes transmitting a data packet from the first device to at least one other device along the particular path. For example, with reference to FIG. 6, the first device 310 transmits data along the path indicated by the path reply message after receiving the path reply message. In this implementation, no path selection is performed. The particular path may traverse the data link group via multiple wireless channels and may include multiple devices of the data link group. For example, with reference to FIG. 6, the particular path includes the devices 310-316 and traverses the first wireless channel 302 and the second wireless channel 304.

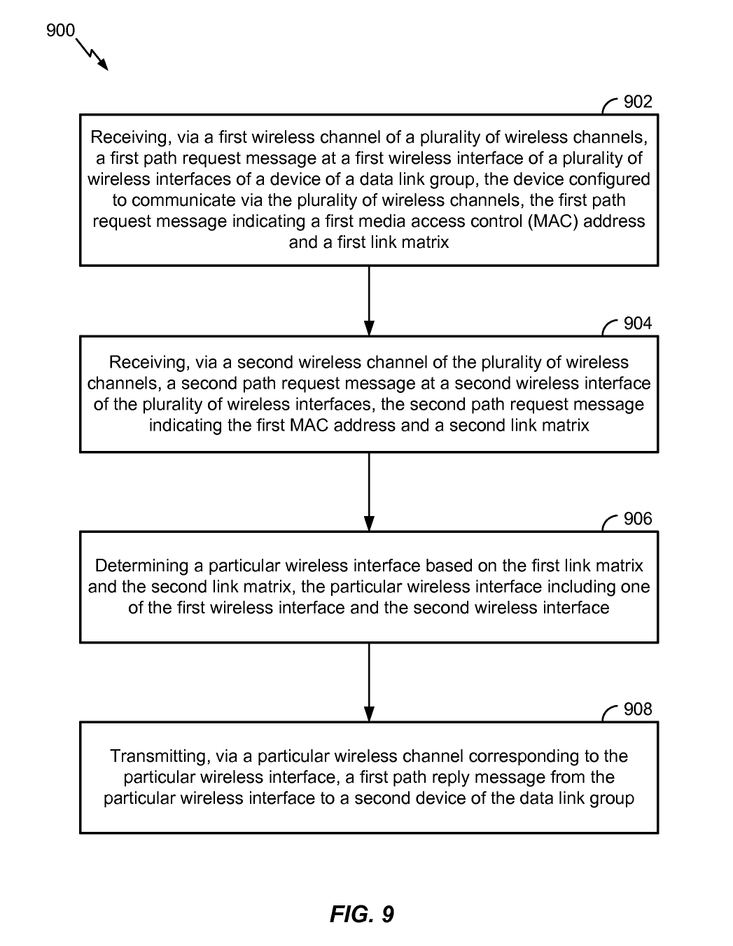

In a particular implementation, the second device may be configured to perform one or more steps described with reference to FIG. 9. In a particular implementation, the second device may be configured to receive, via the first wireless channel, the first path request message at a first particular wireless interface of the second device. The first path request message may further indicate a first link matrix. The second device may be configured to receive, via the second wireless channel, the second path request message at a second particular wireless interface of the second device. The second path request message may further indicate a second link matrix. The second device may be configured to determine a selected wireless interface based on the first link matrix and the second link matrix. The selected wireless interface includes one of the first particular wireless interface and the second particular wireless interface. The second device may also be configured to transmit, via a particular wireless channel corresponding to the selected wireless interface, a first path reply message from the selected wireless interface to a third device of the data link group. These operations of the second device are further described with reference to FIG. 9.

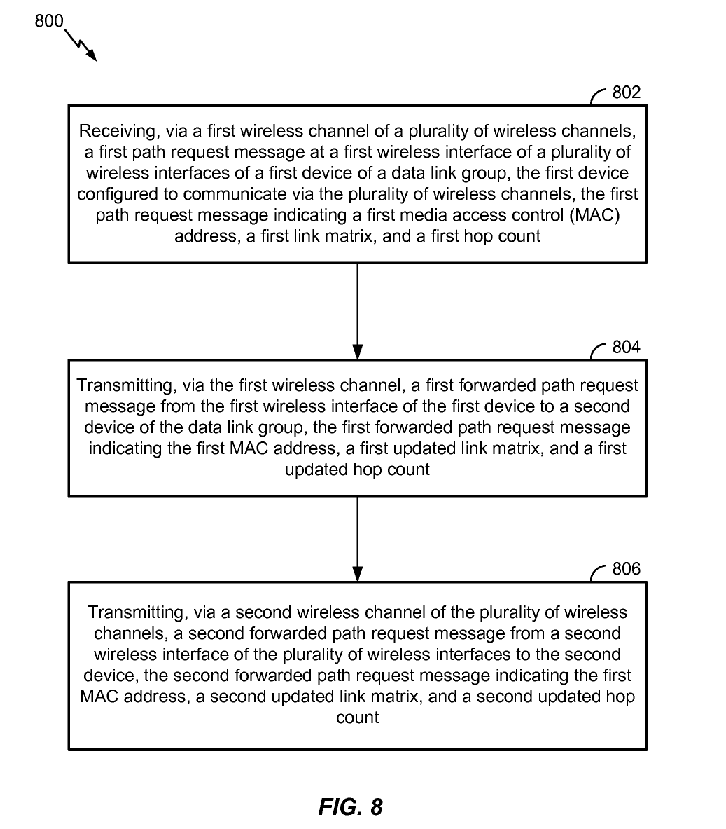

In a particular implementation, the second device may be configured to perform one or more steps described with reference to FIG. 8. In a particular implementation, the second device may be configured to receive, via the first wireless channel, the first path request message at a first particular wireless interface of the second device of a data link group. The first path request message may further indicate a first link matrix and a first hop count. The second device may be configured to transmit, via the first wireless channel, a first forwarded path request message from the first particular wireless interface to a third device of the data link group. The first forwarded path request message may indicate the first MAC address, a first updated link matrix, and a first updated hop count. The second device may also be configured to transmit, via the second wireless channel, a second forwarded path request message from a second particular wireless interface to the third device. The second forwarded path request message indicates the first MAC address, a second updated link matrix, and a second updated hop count. These operations are further described with reference to FIG. 8.

Additionally, the second device may be configured to increment the first hop count by one to generate the first updated hop count and to increment the first hop count by two to generate the second updated hop count, as further described with reference to FIG. 8. Additionally or alternatively, the second device may be configured to update the first link matrix based on a first link metric corresponding to a link between the first wireless interface and the second device to generate the first updated link matrix, and to update the first link matrix based on the first link metric and based on a second link metric corresponding to a link between the first particular wireless interface and the second particular wireless interface to generate the second updated link matrix, as further described with reference to FIG. 8.

Additionally or alternatively, the second device may be configured to receive, via the second wireless channel, a third path request message at the second particular wireless interface, the third path request message indicating a third MAC address. The second device may be configured to transmit, via the second wireless channel, a third forwarded path request message from the second particular wireless interface to the third device, the third forwarded path request message based on the third path request message. The second device may also be configured to transmit, via the first wireless channel, a fourth forwarded path request message from the first particular wireless interface to the third device, the fourth forwarded path request message based on the third path request message. These operations are further described with reference to FIG. 8.

Additionally or alternatively, the second device may be configured to receive, via the second wireless channel, a third path request message at the second particular wireless interface, the third path request message indicating the first MAC address, a second link matrix, and a second hop count. The second device may also be configured to transmit, via the first wireless channel, a third forwarded path request message from the first particular wireless interface to the third device if a second link metric corresponding to the second link matrix is less than or equal to a first link metric corresponding to the first link matrix. Additionally, the second device may be further configured to suppress transmission of the third forwarded path request message if the second link metric exceeds the first link metric. These operations are further described with reference to FIG. 8.

Additionally or alternatively, the second device may be configured to receive, via the first wireless channel, a third path request message at the first particular wireless interface, the third path request message indicating the first MAC address. The second device may be configured to determine that the third path request message corresponds to a fourth path request message transmitted from the second particular wireless interface prior to receipt of the third path request message. The second device may also be configured to suppress transmission of the third path request message. These operations are further described with reference to FIG. 8.

Additionally or alternatively, the second device may be configured to receive, via the first wireless channel, a third path request message at the first particular wireless interface. The third path request message indicates a third MAC address. The second device is configured to determine that the first MAC address and the third MAC address correspond to the same device. The second device is also configured to transmit, via the first wireless channel, a third forwarded path request message from the first particular wireless interface to the third device if a second link metric corresponding to a second link matrix indicated by the third path request message is less than or equal to a first link metric corresponding to the first link matrix. These operations are further described with reference to FIG. 8. In a particular implementation, the second device is further configured to suppress transmission of the third forwarded path request message if the second link metric exceeds the first link metric.

Additionally or alternatively, the second device may be configured to receive, via the first wireless channel, a path reply message at the first particular wireless interface. The second device is configured to increment a second hop count indicated by the path reply message by two to generate a third updated hop count. The second device is configured to update a second link matrix indicated by the path reply message based on a link metric corresponding to a link between the first wireless interface and the second wireless interface to generate a third updated link matrix. The second device may also be configured to transmit, via the second wireless channel, a forwarded path reply message from the second particular wireless interface to a fourth device of the data link group included in a path indicated by the path reply message. The forwarded path reply message indicates the second updated hop count and the third updated link matrix. These operations are further described with reference to FIG. 8.

The method 700 enables a first device of a data link group to transmit path request messages to device(s) of the data link group via multiple wireless channels.

Referring to FIG. 8, a second aspect of a method 800 of operation at a device of a data link group is shown. The method 800 may be performed at any of the devices 110, 120, and 130 of FIG. 1 or any of the devices 310-316 of FIGS. 3-6. In some implementations, steps of the method 800 may be performed in other orders, or one or more steps of the method 800 may be optional.

The method 800 includes receiving, via a first wireless channel of a plurality of wireless channels, a first path request message at a first wireless interface of a plurality of wireless interfaces of a first device of a data link group, at 802. The first device is configured to communicate via the plurality of wireless channels. The first path request message indicates a first MAC address, a first link matrix, and a first hop count. For example, with reference to FIG. 1, the second device 120 receives, via the first wireless channel 102, the first path request message 140 at the third wireless interface 122.

The method 800 includes transmitting, via the first wireless channel, a first forwarded path request message from the first wireless interface of the first device to a second device via of the data link group, at 804. The first forwarded path request message indicates the first MAC address, a first updated link matrix, and a first updated hop count. For example, with reference to FIG. 1, the second device 120 transmits, via the first wireless channel 102, the first copy 142 of the first path request message 140 from the third wireless interface 122 to the third device 130.

The method 800 further includes transmitting, via a second wireless channel of the plurality of wireless channels, a second forwarded path request message from a second wireless interface of the plurality of wireless interfaces to the second device, at 806. The second forwarded path request message indicates the first MAC address, a second updated link matrix, and a second updated hop count. For example, with reference to FIG. 1, the second device 120 transmits, via the second wireless channel 104, the second copy 144 of the first path request message 140 from the fourth wireless interface 126 to the third device 130. The first wireless interface and the second wireless interface may be bridged by a bridging process that emulates a peering process between the second device and the first device. As one example, the peering process may be performed between the first device and the second device to enable the second device to join the data link group. The peering process may also be performed at other times, such as after the second device has joined the data link group by peering with a different device. With reference to FIG. 1, the third wireless interface 122 and the fourth wireless interface 126 are bridged by a bridging process that emulates a peering process between the second device 120 and the third device 130. The data link group may include multiple devices, each of the multiple devices including a pair of bridged wireless interfaces, and the data link group may span multiple wireless channels. For example, with reference to FIG. 1, the data link group includes the devices 110, 120, and 130 (each having two wireless interfaces) and spans the first wireless channel 102 and the second wireless channel 104.

In a particular implementation, the method 800 includes incrementing the first hop count by one to generate the first updated hop count and incrementing the first hop count by two to generate the second updated hop count. For example, with reference to FIG. 1, the message forwarding logic 124 increments the first hop count (indicated by the first path request message 140) by one to generate a first updated hop count and increments the first hop count by two to generate a second incremented hop count. Additionally or alternatively, the method 800 includes updating the first link matrix based on a first link metric corresponding to a link between the first device and a third device (from which the first path request message is received) of the data link group to generate the first updated link matrix. The method 800 further includes updating the first link matrix based on the first link metric and based on a second link metric corresponding to a link between the first wireless interface and the second wireless interface to generate the second updated link matrix. For example, with reference to FIG. 1, the message forwarding logic 124 updates the first link matrix (indicated by the first path request message 140) based on a first link metric corresponding to a link between the second device 120 and the first device 110 to generate the first updated link matrix and updates the first link matrix based on the first link metric and a second link metric corresponding to the link between the third wireless interface 122 and the fourth wireless interface 126 to generate the second updated link matrix. The first updated hop count and the first updated link matrix are indicated by the first copy 142 of the first path request message 140 and the second updated hop count and the second updated link matrix are indicated by the second copy 144 of the first path request message 140.

In another particular implementation, the method 800 includes receiving, via the second wireless channel, a second path request message at the second wireless interface. The second path request message indicates a second MAC address. The method 800 includes transmitting, via the second wireless channel, a third forwarded path request message from the second wireless interface to the second device. The third forwarded path request message is based on the second path request message. The method 800 further includes transmitting, via the first wireless channel, a fourth forwarded path request message from the first wireless interface to the second device. The fourth forwarded path request message is based on the second path request message. For example, with reference to FIG. 1, the second path request message 150 is received at the fourth wireless interface 126, the first copy 152 of the second path request message 150 is transmitted, via second wireless channel 104, from the fourth wireless interface 126 to the third device 130, and the second copy 154 of the second path request message 150 is transmitted, via the first wireless channel 102, from the third wireless interface 122 to the third device 130.

In another particular implementation, the method 800 includes receiving, via the second wireless channel, a second path request message at the second wireless interface. The second path request message indicates the first MAC address, a second link matrix, and a second hop count. The method 800 further includes transmitting, via the first wireless channel, a third forwarded path request message from the first wireless interface to the second device if a second link metric corresponding to the second link matrix is less than or equal to a first link metric corresponding to the first link matrix. For example, with reference to FIG. 1, the second path request message 150 is received at the fourth wireless interface 126 and the second copy 154 of the second path request message 150 is transmitted, via the first wireless channel 102, from the third wireless interface 122 to the third device 130 if the second link metric corresponding to the second link matrix (indicated by the second path request message 150) is less than or equal to the first link metric corresponding to the first link matrix (indicated by the first path request message 140). Additionally, the method 800 may include suppressing transmission of the third forwarded path request message if the second link metric exceeds the first link metric. For example, with reference to FIG. 1, the second copy 154 of the second path request message 150 may be suppressed if the second link metric exceeds the first link metric.

In another particular implementation, the method 800 includes receiving, via the first wireless channel, a second path request message (indicating the first MAC address) at the first wireless interface, determining that the second path request message corresponds to a third path request message transmitted from the second wireless interface prior to receipt of the second path request message, and suppressing transmission of the second path request message. For example, with reference to FIG. 3, the first device 310 receives path request_B1 (22) at the wireless interface A1, determines that path request_B1 (22) corresponds to the path request_A1 (12) previously transmitted from the wireless interface A1, and suppresses transmission of the path request_B1 (22).

In another particular implementation, the method 800 includes receiving, via the first wireless channel, a second path request message (indicating a second MAC address) at the first wireless interface, determining that the first MAC address and the second MAC address correspond to the same device, and transmitting, via the first wireless channel, a third forwarded path request message from the first wireless interface to the second device if a second link metric corresponding to a second link matrix indicated by the second path request message is less than or equal to a first link metric corresponding to the first link matrix. The method may further include suppressing transmission of the third forwarded path request message if the second link metric exceeds the first link metric. For example, with reference to FIG. 5, the second device 312 receives the second path request message at wireless interface B2 and determines whether the originator of the first path request message is the same as the originator of the second path request message. If the second device 312 determines that the first path request message and the second path request message have the same originating device (e.g., the first device 310), the second device suppresses the second path request message if the second link metric value of the second path request message exceeds the first link metric value of the first path request message. The second device 312 forwards the second path request message if the second link metric value does not exceed the first link metric value. In a particular implementation, the method 800 includes determining that the first MAC address and the second MAC address correspond to the same device based on a first token included in the first path request message, a second token included in the second path request message, or a combination thereof Additionally or alternatively, the method 800 includes determining that the first MAC address and the second MAC address correspond to the same device based on a comparison of the first MAC address to the second MAC address.

In another particular implementation, the method 800 includes receiving, via the first wireless channel, a path reply message at the first wireless interface and transmitting, via the second wireless channel, a forwarded path reply message from the second wireless interface to a third device of the data link group included in a path indicated by the path reply message. For example, with reference to FIG. 2, the second path reply message 210 is received, via the first wireless channel 102, at the third wireless interface 122 and a copy 212 of the second path reply message 210 is transmitted, via the second wireless channel 104, from the fourth wireless interface 126 to the first device 110 (according to a path indicated by the second path reply message 210). Additionally, the method 800 may include incrementing a second hop count indicated by the path reply message by two to generate a third updated hop count and updating a second link matrix indicated by the path reply message based on a link metric corresponding to a link between the first wireless interface and the second wireless interface to generate a third updated link matrix. The forwarded path reply message indicates the second updated hop count and the forwarded path reply message indicates the third updated link matrix.

The method 800 enables an intermediate device (between an originator device and a destination device) of a data link group to forward a path request message received at a first wireless interface to the data link group via multiple wireless channels (using multiple wireless interfaces).

Referring to FIG. 9, a third aspect of a method 900 of operation at a device of a data link group is shown. The method 900 may be performed at any of the devices 110, 120, and 130 of FIG. 1 or any of the devices 310-316 of FIGS. 3-6. In some implementations, steps of the method 900 may be performed in other orders, or one or more steps of the method 900 may be optional.

The method 900 includes receiving, via a first wireless channel of a plurality of wireless channels, a first path request message at a first wireless interface of a plurality of wireless interfaces of a device of a data link group, at 902. The device is configured to communicate via the plurality of wireless channels. The first path request message indicates a first MAC address and a first link matrix. For example, with reference to FIG. 1, the third device 130 receives, via the first wireless channel 102, the first copy 142 of the first path request message 140 at the fifth wireless interface 132.

The method 900 includes receiving, via a second wireless channel of the plurality of wireless channels, a second path request message at a second wireless interface of the plurality of wireless interfaces, at 904. The second path request message indicates the first MAC address and a second link matrix. For example, with reference to FIG. 1, the third device 130 receives, via the second wireless channel 104, the second copy 144 of the first path request message 140 at the sixth wireless interface 136.

The method 900 includes determining a particular wireless interface based on the first link matrix and the second link matrix, at 906. The particular wireless interface includes one of the first wireless interface and the second wireless interface. For example, with reference to FIG. 2, the third device 130 may select a first path to the first wireless interface 112 or a second path to the second wireless interface 116 based on link metric values corresponding to the first path and the second path. For example, the third device 130 may select the path having the lowest link metric value as the first path or the second path. The third device 130 may select a particular wireless interface (e.g., the fifth wireless interface 132 or the sixth wireless interface 136) that is in the selected path to transmit a path reply message.

The method 900 further includes transmitting, via a particular wireless channel corresponding to the particular wireless interface, a first path reply message from the particular wireless interface to a second device of the data link group, at 908. For example, with reference to FIG. 2, the third device 130 transmits, via the first wireless channel 102, the first path reply message 202 to the second device 120. The first path reply message 202 may propagate along the first path through the data link group via multiple wireless channels.

The method 900 enables device of a data link group to receive path request messages at multiple wireless interfaces and to send a path reply message along a path corresponding to a lowest link metric.

Although FIGS. 7-10 describe methods 700, 800, and 900, in other implementations, one or more of the steps of the methods 700-900 may be combined with other aspects of the methods 700-900. As a non-limiting example, a step of the method 800 of FIG. 8 or the method 900 of FIG. 9 may be performed by a device described with reference to the method 700 of FIG. 7. Additionally, the steps described in FIGS. 7-9 are described for convenience. In some implementations, steps of the method 700 of FIG. 7, steps the method 800 of FIG. 8, or steps of the method 900 of FIG. 9 may be performed in a different order.

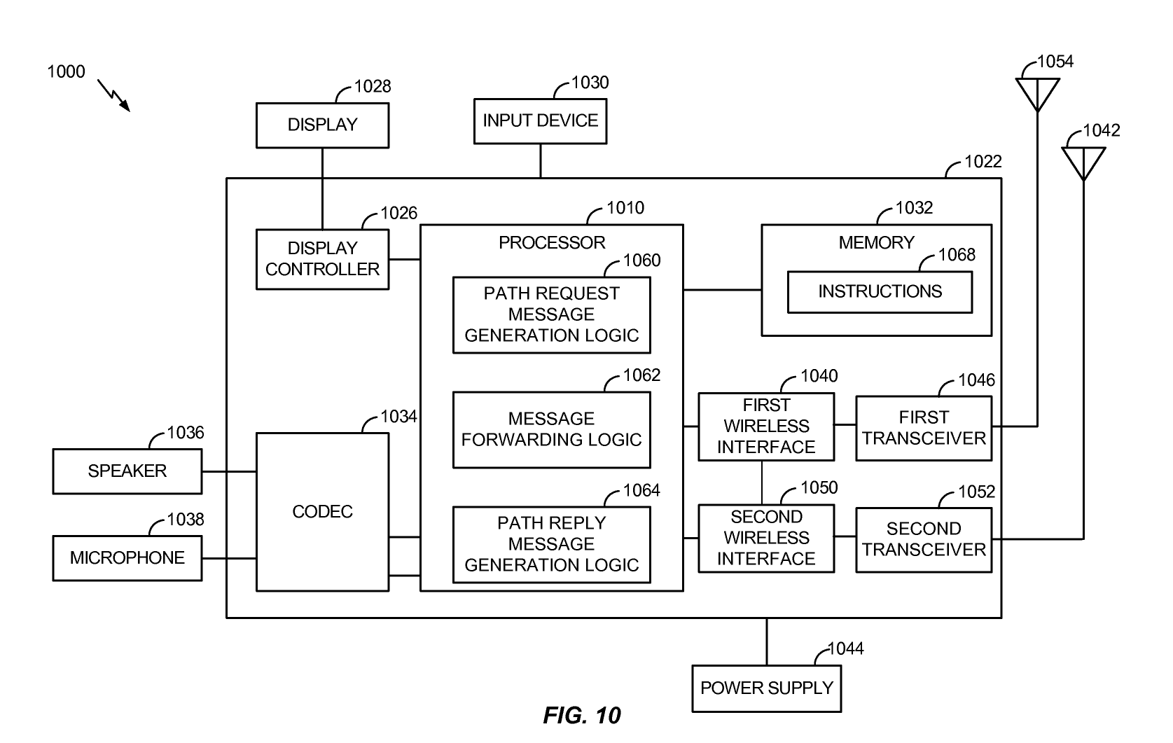

Referring to FIG. 10, a block diagram of a particular illustrative aspect of a wireless communication device 1000 is depicted. The device 1000 includes a processor 1010, such as a digital signal processor (DSP), coupled to a memory 1032. In an illustrative implementation, the device 1000, or components thereof, may correspond to the devices 110, 120, and 130 of FIGS. 1 and 2, the devices 310, 312, 314, and 316 of FIGS. 3-6, or components thereof

The processor 1010 may be configured to execute instructions 1068 (e.g., executable instructions) such as computer-readable instructions or processor-readable instructions stored in the memory 1032. For example, the memory 1032 may include a non-transitory computer-readable medium or a computer-readable storage device that stores the instructions 1068. Additionally or alternatively, the processor 1010 may be configured to execute one or more instructions stored in a memory of a first wireless interface 1040, a second wireless interface 1050, or a combination thereof The first wireless interface 1040 and the second wireless interface 1050 may be Institute of Electrical and Electronics Engineers (IEEE) compliant and may be configured to operate in accordance with a wireless communication standard, including an IEEE 802.11 standard, a Wi-Fi Alliance standard, a NAN standard, or a combination thereof As a non-limiting example, the first wireless interface 1040 and the second wireless interface 1050 may operate in accordance with the IEEE 802.11s standard. In a particular implementation, the processor 1010 may be configured to operate in accordance with one or more of the methods of FIGS. 7-9. To illustrate, the processor 1010 may include path request message generation logic 1060, message forwarding logic 1062, and path reply message generation logic 1064. The processor 1010 may include the path request message generation logic 1060 configured to generate path request messages. In a particular implementation, the path request message generation logic 1060 may be configured to perform the steps of the method 700 of FIG. 7. The processor 1010 may include the message forwarding logic 1062 configured to forward (or suppress) path request messages (and path reply messages). In a particular implementation, the message forwarding logic 1062 may be configured to perform the steps of the method 800 of FIG. 8. The processor 1010 may include the path reply message generation logic 1064 configured to generate path reply messages. In a particular implementation, the path reply message generation logic 1064 may be configured to perform the steps of the method 900 of FIG. 9.

The first wireless interface 1040 may be coupled to the processor 1010 and to a first antenna 1042. For example, the first wireless interface 1040 may be coupled to the first antenna 1042 via a first transceiver 1046, such that wireless data received via the first antenna 1042 may be provided to the processor 1010. The second wireless interface 1050 may be coupled to the processor 1010 and to a second antenna 1054. For example, the second wireless interface 1050 may be coupled to the second antenna 1054 via a second transceiver 1052, such that wireless data received via the second antenna 1054 may be provided to the processor 1010. In some implementations, the first antenna 1042 may be configured to communicate via a first wireless channel, and the second antenna 1054 may be configured to communicate via a second wireless channel. In some implementations, the message forwarding logic 1062 may serve as a bridge between the first wireless interface 1040 and the second wireless interface 1050 by communicating message(s) between the wireless interfaces 1040, 1050. Alternatively, a shared memory (not shown in FIG. 10) may be disposed between the wireless interfaces 1040, 1050 and may include logic to bridge the wireless interfaces 1040, 1050 by communicating message(s), command(s), or a combination thereof

FIG. 10 also illustrates a display controller 1026. The display controller 1026 may be coupled to the processor 1010 and to a display device 1028. A coder/decoder (CODEC) 1034 may also be coupled to the processor 1010. A speaker 1036 and a microphone 1038 may be coupled to the CODEC 1034. In a particular implementation, the processor 1010, the display controller 1026, the memory 1032, the CODEC 1034, the first wireless interface 1040, the second wireless interface 1050, the first transceiver 1046, and the second transceiver 1052 are included in a system-in-package or system-on-chip device 1022. In some implementations, an input device 1030 and a power supply 1044 are coupled to the system-on-chip device 1022. Moreover, in a particular aspect, as illustrated in FIG. 10, the display device 1028, the input device 1030, the speaker 1036, the microphone 1038, the first antenna 1042, the second antenna 1054, and the power supply 1044 are external to the system-on-chip device 1022. However, each of the display device 1028, the input device 1030, the speaker 1036, the microphone 1038, the first antenna 1042, the second antenna 1054, and the power supply 1044 can be coupled to a component of the system-on-chip device 1022, such as an interface or a controllers.

In conjunction with the described aspects, a first apparatus includes means for generating a first path request message and a second path request message at a device (e.g., a device of a data link group), the first path request message indicating a first MAC address, and the second path request message indicating a second MAC address. For example, the means for generating may include the first device 110, the path request message generation logic 114 of FIGS. 1 and 2, one of the devices 310-316 of FIGS. 3-6, the processor 1010 programmed to execute the instructions 1068, the path request message generation logic 1060 of FIG. 10, one or more other devices, circuits, modules, or instructions to generate a first path request message and a second path request message, or any combination thereof.

The first apparatus includes means for transmitting, via a first wireless channel, the first path request message to at least one neighboring device of the data link group. For example, the means for transmitting the first path request message may include the first device 110, the first wireless interface 112 of FIGS. 1 and 2, one of the devices 310-316 of FIGS. 3-6, the processor 1010 programmed to execute the instructions 1068, the path request message generation logic 1060, the first wireless interface 1040 of FIG. 10, one or more other devices, circuits, modules, or instructions to transmit the first path request message via a first wireless channel, or any combination thereof. The first MAC address may identify the means for transmitting the first path request message.

The first apparatus also includes means for transmitting, via a second wireless channel, the second path request message to the at least one neighboring device. For example, the means for transmitting the second path request message may include the first device 110, the second wireless interface 116 of FIGS. 1 and 2, one of the devices 310-316 of FIGS. 3-6, the processor 1010 programmed to execute the instructions 1068, the path request message generation logic 1060, the second wireless interface 1050 of FIG. 10, one or more other devices, circuits, modules, or instructions to transmit the second path request message via a second wireless channel, or any combination thereof The second MAC address may identify the means for transmitting the second path request message.

In conjunction with the described aspects, a second apparatus includes means for receiving, via a first wireless channel of a plurality of wireless channels, a first path request message, the first path request message indicating a first MAC address, a first link matrix, and a first hop count. For example, the means for receiving may include the second device 120, the third wireless interface 122 of FIGS. 1 and 2, one of the devices 310-316 of FIGS. 3-6, the processor 1010 programmed to execute the instructions 1068, the first wireless interface 1040 of FIG. 10, one or more other devices, circuits, modules, or instructions to receive a first path request message, or any combination thereof.

The second apparatus includes means for transmitting, via the first wireless channel, a first forwarded path request message to at least one neighboring device of a data link group, the first forwarded path request message indicating the first MAC address, a first updated link matrix, and a first updated hop count. For example, the means for transmitting the first forwarded path request message may include the second device 120, the message forwarding logic 124, the third wireless interface 122 of FIGS. 1 and 2, one of the devices 310-316 of FIGS. 3-6, the processor 1010 programmed to execute the instructions 1068, the message forwarding logic 1062, the first wireless interface 1040 of FIG. 10, one or more other devices, circuits, modules, or instructions to transmit the first forwarded path request message via a first wireless channel, or any combination thereof.

The second apparatus also includes means for transmitting, via a second wireless channel of a plurality of wireless channels, a second forwarded path request message to the at least one neighboring device, the second forwarded path request message indicating the first MAC address, a second updated link matrix, and a second updated hop count. For example, the means for transmitting the second forwarded path request message may include the second device 120, the message forwarding logic 124, the fourth wireless interface 126 of FIGS. 1 and 2, one of the devices 310-316 of FIGS. 3-6, the processor 1010 programmed to execute the instructions 1068, the message forwarding logic 1062, the second wireless interface 1050 of FIG. 10, one or more other devices, circuits, modules, or instructions to transmit the second forwarded path request message via a second wireless channel, or any combination thereof.

In conjunction with the described aspects, a third apparatus includes means for receiving, via a first wireless channel of a plurality of wireless channels, a first path request message from a first device of a data link group, the first path request message indicating a first MAC address and a first link matrix. For example, the means for receiving the first path request message may include the third device 130, the fifth wireless interface 132 of FIGS. 1 and 2, one of the devices 310-316 of FIGS. 3-6, the processor 1010 programmed to execute the instructions 1068, the first wireless interface 1040 of FIG. 10, one or more other devices, circuits, modules, or instructions to receive a first path request message via a first wireless channel, or any combination thereof

The third apparatus includes means for receiving, via a second wireless channel of a plurality of wireless channels, a second path request message from a second device of the data link group, the second path request message indicating the first MAC address and a second link matrix. For example, the means for receiving the second path request message may include the third device 130, the sixth wireless interface 136 of FIGS. 1 and 2, one of the devices 310-316 of FIGS. 3-6, the processor 1010 programmed to execute the instructions 1068, the second wireless interface 1050 of FIG. 10, one or more other devices, circuits, modules, or instructions to receive a second path request message via a second wireless channel, or any combination thereof

The third apparatus includes means for determining a particular wireless channel based on the first link matrix and the second link matrix, the particular wireless channel including one of the first wireless channel and the second wireless channel. For example, the means for determining may include the third device 130, the path reply message generation logic 134 of FIGS. 1 and 2, one of the devices 310-316 of FIGS. 3-6, the processor 1010 programmed to execute the instructions 1068, the path reply message generation logic 1064 of FIG. 10, one or more other devices, circuits, modules, or instructions to determine a particular wireless channel based on a first link matrix and a second link matrix, or any combination thereof

The third apparatus also includes means for transmitting, via the particular wireless channel, a path reply message to at least one neighboring device of the data link group. For example, the means for transmitting the path reply message may include the third device 130, the path reply message generation logic 134, the fifth wireless interface 132, the sixth wireless interface 136 of FIGS. 1 and 2, one of the devices 310-316 of FIGS. 3-6, the processor 1010 programmed to execute the instructions 1068, the path reply message generation logic 1064, the first wireless interface 1040, the second wireless interface 1050 of FIG. 10, one or more other devices, circuits, modules, or instructions to transmit the second path request message via the particular wireless channel, or any combination thereof

One or more of the disclosed aspects may be implemented in a system or an apparatus, such as the device 1000, that may include a communications device, a personal digital assistant (PDA), a mobile phone, a cellular phone, a navigation device, a computer, a portable computer, a desktop computer, or any combination thereof As other examples, the device 1000 may include a set top box, an entertainment unit, a fixed location data unit, a mobile location data unit, a monitor, a computer monitor, a television, a tuner, or any combination thereof As other examples, the device 1000 may include a radio, a satellite radio, a music player, a digital music player, a portable music player, a video player, a digital video player, a digital video disc (DVD) player, a portable digital video player, or any other device that stores or retrieves data or computer instructions, or any combination thereof.

Although one or more of FIGS. 1-10 illustrate systems, apparatuses, and/or methods according to the teachings of the disclosure, the disclosure is not limited to these illustrated systems, apparatuses, and/or methods. One or more functions or components of any of FIGS. 1-10 as illustrated or described herein may be combined with one or more other portions of another of FIGS. 1-10. Accordingly, no single implementation described herein should be construed as limiting and implementations of the disclosure described with reference to one figure may be suitably combined with implementations described with reference to other figures without departing from the teachings of the disclosure.

Those of skill in the art would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the disclosure herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (e.g., non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal In the alternative, the processor and the storage medium may reside as discrete components in a computing device or user terminal

The previous description is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A method for wireless communication, the method comprising:
generating a first path request message and a second path request message at a first device of a data link group, the first path request message indicating a first media access control (MAC) address corresponding to a first wireless interface of a plurality of wireless interfaces of the first device and the second path request message indicating a second MAC address corresponding to a second wireless interface of the plurality of wireless interfaces;
transmitting, via a first wireless channel, the first path request message from the first wireless interface to a second device of the data link group; and
transmitting, via a second wireless channel, the second path request message from the second wireless interface to the second device.

2. The method of claim 1, wherein the first wireless channel is within a first frequency band, wherein the second wireless channel is within a second frequency band, and wherein the second frequency band is different than the first frequency band.

3. The method of claim 1, wherein the first wireless channel and the second wireless channel are different wireless channels within the same frequency band.

4. The method of claim 1, wherein the first path request message indicates a particular sequence number, a first link matrix, and a first hop count, and wherein the second path request message indicates the particular sequence number, a second link matrix, and a second hop count.

5. The method of claim 1, wherein the first path request message and the second path request message are Path Request (PREQ) messages generated in accordance with a hybrid wireless mesh protocol (HWMP) specified by an Institute of Electrical and Electronics Engineers (IEEE) 802.11s standard.

6. The method of claim 1, wherein the first MAC address and the second MAC address are different MAC addresses.

7. The method of claim 1, wherein the first MAC address and the second MAC address are derived from a particular MAC address corresponding to the first device.

8. The method of claim 1, wherein the first MAC address corresponds to the first device, and wherein the second path request message includes a token, the token indicating the second path request message corresponds to the first device.

9. The method of claim 1, wherein the data link group includes a plurality of devices of a neighbor aware network (NAN).

10. The method of claim 1, further comprising:
receiving, via the first wireless channel, a first path reply message at the first wireless interface, the first path reply message indicating a first path through the data link group between the first device and a destination device; and
receiving, via the second wireless channel, a second path reply message at the second wireless interface, the second path reply message indicating a second path through the data link group between the first device and the destination device.

11. The method of claim 10, wherein the first path, the second path, or both, traverse the data link group via multiple wireless channels, wherein the first path, the second path, or both, include multiple devices of the data link group, and wherein the first path reply message and the second path reply message are Path Reply (PREP) messages generated in accordance with a hybrid wireless mesh protocol (HWMP) specified by an Institute of Electrical and Electronics Engineers (IEEE) 802.11s standard.

12. The method of claim 10, further comprising:
determining a particular path based on a comparison of a first link metric corresponding to the first path and a second link metric corresponding to the second path; and
transmitting a data packet from the first device to at least one other device along the particular path.

13. The method of claim 12, wherein determining the particular path includes:
comparing the first link metric of a first link matrix indicated by the first path reply message to the second link metric of a second link matrix indicated by the second path reply message, the first link metric corresponding to the first path and the second link metric corresponding to the second path;
selecting the first path as the particular path if the first link metric is less than or equal to the second link metric; and
selecting the second path as the particular path if the first link metric exceeds the second link metric.

14. The method of claim 12, wherein the particular path traverses multiple wireless interfaces of the second device.

15. The method of claim 1, further comprising:
receiving a path reply message at a particular wireless interface, wherein the particular wireless interface is one of the first wireless interface and the second wireless interface, wherein the path reply message indicates a particular path through the data link group between the first device and a destination device, and wherein the particular path traverses the data link group via multiple wireless channels and includes multiple devices of the data link group; and
transmitting a data packet from the first device to at least one other device along the particular path.

16. The method of claim 1, wherein the first wireless interface and the second wireless interface are bridged by a bridging process.

17. An apparatus comprising:
message generation logic configured to generate a first path request message and a second path request message, the first path request message indicating a first media access control (MAC) address and the second path request message indicating a second MAC address;
a first wireless interface configured to transmit, via a first wireless channel, the first path request message to a second device of a data link group; and
a second wireless interface configured to transmit, via a second wireless channel, the second path request message to the second device.

18. The apparatus of claim 17, wherein the second device is configured to:
receive, via the first wireless channel, the first path request message at a first particular wireless interface of the second device, wherein the first path request message further indicates a first link matrix;
receive, via the second wireless channel, the second path request message at a second particular wireless interface of the second device, wherein the second path request message further indicates a second link matrix;
determine a selected wireless interface based on the first link matrix and the second link matrix, the selected wireless interface including one of the first particular wireless interface and the second particular wireless interface; and
transmit, via a particular wireless channel corresponding to the selected wireless interface, a first path reply message from the selected wireless interface to a third device of the data link group.

19. The apparatus of claim 17, wherein the second device is configured to:
receive, via the first wireless channel, the first path request message at a first particular wireless interface of the second device, wherein the first path request message further indicates a first link matrix and a first hop count;
transmit, via the first wireless channel, a first forwarded path request message from the first particular wireless interface to a third device of the data link group, the first forwarded path request message indicating the first MAC address, a first updated link matrix, and a first updated hop count;
and transmit, via the second wireless channel, a second forwarded path request message from a second particular wireless interface to the third device, the second forwarded path request message indicating the first MAC address, a second updated link matrix, and a second updated hop count.

20. The apparatus of claim 19, wherein the second device is configured to:
increment the first hop count by one to generate the first updated hop count; and
increment the first hop count by two to generate the second updated hop count.

21. The apparatus of claim 19, wherein the second device is configured to:
update the first link matrix based on a first link metric corresponding to a link between the first wireless interface and the second device to generate the first updated link matrix; and
update the first link matrix based on the first link metric and based on a second link metric corresponding to a link between the first particular wireless interface and the second particular wireless interface to generate the second updated link matrix.

22. The apparatus of claim 19, wherein the second device is configured to:
receive, via the second wireless channel, a third path request message at the second particular wireless interface, the third path request message indicating a third MAC address;
transmit, via the second wireless channel, a third forwarded path request message from the second particular wireless interface to the third device, the third forwarded path request message based on the third path request message; and
transmit, via the first wireless channel, a fourth forwarded path request message from the first particular wireless interface to the third device, the fourth forwarded path request message based on the third path request message.

23. The apparatus of claim 19, wherein the second device is configured to:
receive, via the second wireless channel, a third path request message at the second particular wireless interface, the third path request message indicating the first MAC address, a second link matrix, and a second hop count; and
transmit, via the first wireless channel, a third forwarded path request message from the first particular wireless interface to the third device if a second link metric corresponding to the second link matrix is less than or equal to a first link metric corresponding to the first link matrix.

24. The apparatus of claim 23, wherein the second device is further configured to suppress transmission of the third forwarded path request message if the second link metric exceeds the first link metric.

25. The apparatus of claim 19, wherein the second device is configured to:
receive, via the first wireless channel, a third path request message at the first particular wireless interface, the third path request message indicating the first MAC address;
determine that the third path request message corresponds to a fourth path request message transmitted from the second particular wireless interface prior to receipt of the third path request message; and
suppress transmission of the third path request message.

26. The apparatus of claim 19, wherein the second device is configured to:
receive, via the first wireless channel, a third path request message via at the first particular wireless interface, the third path request message indicating a third MAC address;
determine that the first MAC address and the third MAC address correspond to the same device; and
transmit, via the first wireless channel, a third forwarded path request message from the first particular wireless interface to the third device if a second link metric corresponding to a second link matrix indicated by the third path request message is less than or equal to a first link metric corresponding to the first link matrix.

27. The apparatus of claim 26, wherein the second device is further configured to suppress transmission of the third forwarded path request message if the second link metric exceeds the first link metric.

28. The apparatus of claim 19, wherein the second device is configured to:
receive, via the first wireless channel, a path reply message at the first particular wireless interface;
increment a second hop count indicated by the path reply message by two to generate a third updated hop count;
update a second link matrix indicated by the path reply message based on a link metric corresponding to a link between the first wireless interface and the second wireless interface to generate a third updated link matrix; and
transmit, via the second wireless channel, a forwarded path reply message from the second particular wireless interface to a fourth device of the data link group included in a path indicated by the path reply message, the forwarded path reply message indicating the second updated hop count and the third updated link matrix.

29. An apparatus for wireless communication, the apparatus comprising:
means for generating a first path request message and a second path request message at a device, the first path request message indicating a first media access control (MAC) address, and the second path request message indicating a second MAC address;
means for transmitting, via a first wireless channel, the first path request message to at least one neighboring device of a data link group; and
means for transmitting, via a second wireless channel, the second path request message to the at least one neighboring device.

30. A non-transitory computer readable medium storing instructions that, when executed by a processor, cause the processor to:
generate a first path request message and a second path request message at a device of a data link group, the first path request message indicating a first media access control (MAC) address corresponding to a first wireless interface of the device, and the second path request message indicating a second MAC address corresponding to a second wireless interface of the device;
transmit, via a first wireless channel, the first path request message from the first wireless interface to at least one neighboring device of the data link group; and
transmit, via a second wireless channel, the second path request message from the second wireless interface to the at least one neighboring device.
